(19) United States
(12) Patent Application Publication
(10) Pub. No.: US 2026/0300797 A1
(43) Pub. Date: Oct. 1, 2026

(54) Quantum Error Correction Decoding via Block-and-Cycle Feasibility Checking

(71) Applicant: International Business Machines Corporation, Armonk, NY (US)

(72) Inventors: Michael BEVERLAND, Seattle, WA (US); Sergey BRAVYI, Ossining, NY (US)

(21) Appl. No.: 19/089,502

(22) Filed: Mar. 25, 2025

(51) Int. Cl. G06N 10/70; G06N 10/20

(52) U.S. Cl. CPC G06N 10/70; G06N 10/20

(57) ABSTRACT

Systems/techniques that facilitate quantum error correction decoding via block-and-cycle feasibility checking are provided. In various embodiments, a system can measure a syndrome measurement associated with a quantum error correction circuit and a parity check matrix. In various aspects, the system can identify a logical action caused by an error afflicting the quantum error correction circuit, based on performing block-and-cycle feasibility checking on a first linear system derived from the syndrome measurement and from the parity check matrix. In various instances, the system can correct the error, based on applying an inverse of the logical action to the quantum error correction circuit.

### BACKGROUND

The subject disclosure relates to quantum error correction. When given a syndrome measurement of a quantum error correction code, it can be desired to determine or identify what error caused such syndrome measurement. Existing techniques facilitate such determination or identification using ordered statistics decoding (OSD). Unfortunately, such existing techniques consume excessive amounts of computer runtime and computer memory.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate quantum error correction decoding via block-and-cycle feasibility checking are described.

According to one or more embodiments, a system is provided. In various aspects, the system can comprise a processor that can execute computer-executable instructions stored in a non-transitory computer-readable memory. In various instances, such execution can cause the processor to facilitate various operations. In various cases, such operations can include measuring a syndrome measurement associated with a quantum error correction circuit and a parity check matrix. In various aspects, such operations can include identifying, by the device, a logical action caused by an error afflicting the quantum error correction circuit, based on performing block-and-cycle feasibility checking on a first linear system derived from the syndrome measurement and from the parity check matrix. In various instances, such operations can include correcting the error based on applying an inverse of the logical action to the quantum error correction circuit.

In various aspects, the above-described system can be reformulated, reformatted, or otherwise implemented as a computer-implemented method or as a computer program product.

### DESCRIPTION OF THE DRAWINGS

FIG. 1 illustrates a block diagram of an example, non-limiting system that facilitates quantum error correction decoding via block-and-cycle feasibility checking in accordance with one or more embodiments described herein.

FIG. 2 illustrates an example, non-limiting diagram of a parity check matrix in accordance with one or more embodiments described herein.

FIG. 3 illustrates an example, non-limiting diagram of a logical action matrix in accordance with one or more embodiments described herein.

FIG. 4 illustrates a block diagram of an example, non-limiting system including a candidate error and a plurality of column-wise reliabilities that facilitates quantum error correction decoding via block-and-cycle feasibility checking in accordance with one or more embodiments described herein.

FIG. 5 illustrates an example, non-limiting block diagram showing how a candidate error and a plurality of column-wise reliabilities can be generated in accordance with one or more embodiments described herein.

FIG. 6 illustrates a block diagram of an example, non-limiting system including a logical action and a block-and-cycle feasibility checking algorithm that facilitates quantum error correction decoding via block-and-cycle feasibility checking in accordance with one or more embodiments described herein.

FIGS. 7-12 illustrate example, non-limiting diagrams showing how a logical action can be identified via a block-and-checking feasibility checking algorithm in accordance with one or more embodiments described herein.

FIGS. 13-16 illustrate example, non-limiting experimental results in accordance with one or more embodiments described herein.

FIG. 17 illustrates a flow diagram of an example, non-limiting computer-implemented method that facilitates quantum error correction decoding via block-and-cycle feasibility checking in accordance with one or more embodiments described herein.

FIG. 18 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A quantum computer can be any suitable device that utilizes a qubit lattice (e.g., a plurality of superconducting qubits fabricated on one or more quantum substrates and exhibiting any suitable connection topology) for information processing. A quantum circuit can be a sequence of any suitable number of parallel or series quantum gates that can be executed on a quantum computer. A quantum gate can be a basic component of a quantum circuit that can change, alter, or otherwise affect the state of a qubit. As some non-limiting examples, a quantum gate can be any suitable single-qubit gate (e.g., Pauli-X gates, Pauli-Y gates, Pauli-Z gates, Phase gates, Rotation gates, Hadamard gates) or any suitable entangling or two-qubit gate (e.g., Controlled-Not gates, Controlled-Phase gates). Quantum gates can be combined in series via matrix multiplication or in parallel via tensor products.

Quantum error correction (QEC) can be considered as a set of tools or strategies for detecting and correcting logical or computing errors that occur on noisy quantum hardware. Recall that measuring the quantum state of a qubit causes that quantum state to collapse from whatever superposition it is currently in to either |0 [symbol] or |1 [symbol] . Because of such collapse, QEC refrains from measuring the quantum states of logical qubits (e.g., of whichever qubits are specifically intended to perform a given quantum computation). Instead, QEC measures the quantum states of ancillary qubits (e.g., of extra or additional qubits) that are coupled to the logical qubits or that otherwise interact with the logical qubits through controlled gates (e.g., through Controlled-Not gates). The measured quantum states of the ancillary qubits, which can be referred to as syndrome measurements, can provide information regarding what type of error (e.g., bit-flip error, phase-flip error), if any, has afflicted the logical qubits, without causing the quantum states of the logical qubits to collapse. After the error is identified, QEC can involve correcting the error by applying an inverse of the error to the logical qubits.

When given a syndrome measurement s of a QEC circuit, error identification is generally accomplished in a two-stage fashion: pre-decoding followed by decoding. First, a pre-decoding algorithm, such as belief propagation, is applied to the syndrome measurement s and to a parity check matrix H associated with the QEC circuit. Such pre-decoding algorithm produces as output a candidate error e_{BP} and column-wise fault probabilities respectively corresponding to the columns of the parity check matrix. If a product between the candidate error e_{BP} and the parity check matrix H is equal to the syndrome measurement s, the candidate error e_{BP} is concluded to be the error e that afflicted the QEC circuit. Instead, if the product between the candidate error e_{BP} and the parity check matrix H is not equal to the syndrome measurement s, a decoding algorithm is applied to the candidate error e_{BP} and to the column-wise fault probabilities. The decoding algorithm can be considered as identifying the actual error e that afflicted the QEC circuit, given the candidate error e_{BP} (e.g., can be considered as filling in the gap left by belief propagation).

The decoding algorithm implemented by existing techniques is referred to as ordered statistics decoding (OSD). OSD involves solving a linear system which equates: a product between the parity check matrix H and an unknown vector Δe; to a residual syndrome s_{BP} derived from the candidate error e_{BP}. That is, OSD solves the linear system HΔe=s_{BP}, where an unknown vector Δe can, when added to the candidate error e_{BP}, yield the actual error e. That is, e=e_{BP}+Δe. Because the parity check matrix H can be massive (e.g., having thousands or even millions of rows and columns), inverting (e.g., via Gaussian elimination) the parity check matrix H to solve such linear system can be highly computationally-intensive. In an attempt to address this massive consumption of computing resources, OSD involves creating a dimensionally-reduced linear system that omits columns of the parity check matrix which are conclusively not faults (e.g., omits columns whose fault probabilities are below a threshold). If needed to attain invertibility, the non-omitted columns can be padded in order of decreasing fault probability with one or more columns that would otherwise be omitted. In any case, OSD inverts this subset of columns of the parity check matrix H, which can be less computationally-expensive than inverting the parity check matrix H in its entirety. More specifically, the dimensionally-reduced linear system is given by H_{faults}ê_{faults}=s_{BP}, where H_{faults} represents the matrix formed by the non-omitted columns of H, where ê_{faults} is an unknown vector to be identified, and where ê_{faults} can, when concatenated with a respective zero for each omitted column of H, be considered as Δe. OSD solves this dimensionally-reduced linear system via inversion, such that

$${\hat{e}}_{faults} = {H}_{faults}^{- 1} {s}_{BP} .$$

Unfortunately, although OSD can consume fewer computational resources than would inversion of H in its entirety, OSD can nevertheless be considered as consuming unacceptably large amounts of computational resources. Indeed, the computational runtime of OSD is proportional to: the cube of the total number of logical qubits and ancillary qubits involved in the QEC circuit; and the cube of the number of cycles that make up the parity check matrix. Additionally, the computer memory space taken up by OSD is proportional to: the square of the total number of logical qubits and ancillary qubits involved in the QEC circuit; and the square of the number of cycles that make up the parity check matrix.

Accordingly, systems or techniques that can facilitate QEC decoding with less computational resource consumption than OSD can be considered as desirable.

Various embodiments described herein can address one or more of these technical problems. Various embodiments described herein can include systems, computer-implemented methods, apparatus, or computer program products that can facilitate QEC decoding via block-and-cycle feasibility checking. At a high level, the inventors of various embodiments described herein devised various techniques for facilitating QEC decoding that consume less runtime and less computer memory space than OSD. At a more granular level, the present inventors achieved such reduction in runtime and computer memory space by leveraging the fact that an error e which afflicts a QEC circuit is distinct from the logical action (e.g., from the quantum state transformation) which that error e works or performs on the QEC circuit. Usually, QEC involves identifying the error e and subsequently computing its logical action a by leveraging a logical action matrix L associated with the QEC circuit, such that a=Le. The present inventors realized that a significant amount of runtime and memory space can be saved by identifying the logical action a directly, without first identifying the error e. After all, as the present inventors recognized, different errors might have or perform the same logical action on the QEC circuit as each other (e.g., errors that differ by a stabilizer have the same syndrome measurements and logical actions as each other). So, the present inventors realized that no effort needs to be spent on trying to distinguish or disambiguate between such errors, contrary to the teachings and design of OSD. The present inventors concocted various techniques for computing the logical action a of an error e without first computing the error e itself. Such techniques rely upon what can be referred to as a block-and-cycle feasibility checking algorithm.

As described herein, the block-and-cycle feasibility checking algorithm can be considered as a computerized protocol that quickly and efficiently computes the logical action a caused by some unknown error e when given a syndrome measurement s, a parity check matrix H, and a logical action matrix L, by leveraging or otherwise making use of the fact that the parity check matrix H and the logical action matrix L are organized or constructed according to blocks and cycles. More specifically, the parity check matrix H and the logical action matrix L can each be composed of blocks (e.g., regular or repeating sub-matrices) that are organized according to a sequence of syndrome measurement cycles. Now, rather than considering the full linear system HΔe=s_{BP}, the block-and-cycle feasibility checking algorithm can instead consider a dimensionally-reduced linear system given by H_{U}ê_{U}=s_{BP}, where H_{U} is formed by a subset of columns U from the parity check matrix H, and where ê_{U} is an unknown variable. In some cases, the subset of columns U can be the same subset chosen to form H_{faults} mentioned above (such that H_{U}=H_{faults}). In other cases, however, the subset of columns U can instead be whichever columns of H that belief propagation least reliably classified as faults or not faults (such that H_{U}≠H_{faults}). In either situation, the block-and-cycle feasibility checking algorithm can refrain from inverting H_{U}. Instead, the block-and-cycle feasibility checking algorithm can, for each syndrome measurement cycle, create an even smaller linear system whose coefficients are formed by stacking whichever blocks of the parity check matrix H, as restricted to the subset of columns U, correspond to that syndrome measurement cycle with or on top of whichever blocks of the logical action matrix L, as restricted to the subset of columns U, correspond to that syndrome measurement cycle. Moreover, the variables of such even smaller linear system can include not just blocks from the unknown vector \vec{e}_{U} corresponding to that syndrome measurement cycle but also an auxiliary variable that is, as described later herein, configured to track cumulative logical action across measurement cycles. This even smaller linear system can be many orders of magnitude smaller in terms of dimensionality than H_{U}ê_{U}=s_{BP}, which is already significantly smaller in terms of dimensionality than HΔe=s_{BP}. Thus, inversion can be applied to this even smaller linear system using significantly less time and memory space than would inversion of H_{U} or inversion of H.

Note that the block-and-cycle feasibility checking algorithm can be considered as evaluating the linear system H_{U}ê_{U}=s_{BP} one cycle at a time, taking into account only whichever blocks of the parity check matrix H and of the logical action matrix L that belong to whichever cycle is currently under consideration. Conceptually, this can be thought of as decomposing the linear system H_{U}ê_{U}=s_{BP} into several miniature or “bite-sized” linear systems to which matrix inversion can easily, conveniently, or inexpensively be applied. By leveraging the block-and-cycle architectures of H and L in this way, various embodiments described herein can perform QEC decoding using significantly less computer runtime or memory space as compared to OSD, which instead completely ignores the block-and-cycle architectures of H and L.

Various embodiments described herein can be considered as a computerized tool (e.g., any suitable combination of computer-executable hardware or computer-executable software) that can facilitate QEC decoding via block-and-cycle feasibility checking. In various aspects, such a computerized tool can have an access component, a pre-decoder component, a decoder component, or a correction component.

In various embodiments, there can be a quantum computer. In various aspects, the quantum computer can include any suitable number of qubits. In various instances, such qubits can exhibit any suitable structures, constructions, or architectures (e.g., can be superconducting qubits, spin qubits, or quantum dots). In various cases, some of such qubits can be considered or otherwise referred to as logical qubits, and others of such qubits can be considered or otherwise referred to as ancillary qubits. In various aspects, the logical qubits and ancillary qubits of the quantum computer can be arranged or connected according to any suitable coupling topology.

In various instances, there can be a QEC circuit. In various cases, the QEC circuit can be configured to perform any suitable quantum computation on the logical qubits of the quantum computer and to detect errors in such quantum computation using the ancillary qubits of the quantum computer.

In various aspects, there can be a syndrome measurement associated with the QEC circuit. Indeed, the QEC circuit can be executed on the quantum computer using any suitable quantum state initialization for the logical qubits and ancillary qubits, and the syndrome measurement can be extracted during or from such execution via any suitable quantum measurement or readout hardware. The syndrome measurement can be formatted as a bitstring whose length is proportional to the total number of qubits involved in the QEC circuit and to a total number of measurement cycles involved in syndrome extraction.

In various instances, there can be a parity check matrix associated with the QEC circuit. In various cases, the parity check matrix can be a sparse, binary matrix that exhibits a block structure which is known or deemed to check parity of the QEC circuit. In particular, the parity check matrix can be composed of repeating blocks that are arranged in an almost-diagonal layout. The number of block-rows of the parity check matrix can be equal to the total number of measurement cycles, and the number of block-columns of the parity check matrix can be equal to twice the total number of measurement cycles. It should be understood or otherwise appreciated that the particular content of the blocks of the parity check matrix can depend upon the content or structure of the QEC circuit (e.g., different repeating parity check blocks can be used for different QEC circuits). Note that the number of rows and number of columns that make up each block of the parity check matrix can each be proportional to the total number of qubits (both logical qubits and ancillary qubits) that are involved in the QEC circuit.

In various aspects, there can be a logical action matrix associated with the QEC circuit. In various instances, the logical action matrix can be a binary matrix that exhibits a block structure and that is known or deemed to represent whatever quantum state transformations are performed or caused on the logical qubits by respective errors detected by the parity check matrix. In particular, the logical action matrix can be composed of repeating blocks that are arranged as a single chain. Indeed, the number of block-rows of the logical action matrix can be equal to one, and the number of block-columns of the logical action matrix can be equal to twice the total number of measurement cycles. Just as above, it should be understood or otherwise appreciated that the particular content of the blocks of the logical action matrix can depend upon the QEC circuit (e.g., different repeating logical action blocks can be used for different QEC circuits). Note that the number of rows that make up each block of the logical action matrix can be equal to the total number of logical qubits involved in the QEC circuit (that is, excluding ancillary qubits), whereas the number of columns that make up each block of the logical action matrix can be proportional to the total number of qubits (both logical qubits and ancillary qubits) that are involved in the QEC circuit.

In various cases, it can be desired to determine what erroneous logical action afflicted the execution of the QEC circuit, based on the syndrome measurement, the parity check matrix, and the logical action matrix. As described herein, the computerized tool can facilitate such determination.

In various embodiments, the access component of the computerized tool can electronically access, via any suitable wired or wireless electronic connections, the quantum computer. That is, the access component can electronically communicate with (e.g., send electronic instructions to, receive electronic data from) the quantum computer. In various instances, the access component can further access or otherwise receive, retrieve, or import from any suitable source the QEC circuit, the syndrome measurement, the parity check matrix, and the logical action matrix. For example, the access component can obtain the QEC circuit, the syndrome measurement, the parity check matrix, or the logical action matrix from any suitable centralized or decentralized data structures (e.g., graph data structures, relational data structures, hybrid data structures), whether remote from or local to the access component. In any case, the access component can access the quantum computer, the QEC circuit, the syndrome measurement, the parity check matrix, and the logical action matrix, such that other components of the computerized tool can electronically interact with (e.g., power-up, power-down, initialize, control) the quantum computer or can electronically interact with (e.g., read, write, edit, copy, manipulate, execute) the QEC circuit, the syndrome measurement, the parity check matrix, and the logical action matrix.

In various embodiments, the pre-decoder component of the computerized tool can electronically generate a candidate error and a plurality of reliabilities that respectively correspond to the columns of the parity check matrix. In various aspects, the pre-decoder component can accomplish such generation by applying any suitable pre-decoding algorithm, such as belief propagation, to the QEC circuit, to the syndrome measurement, and to the parity check matrix. In particular, application of belief propagation to the QEC circuit, to the syndrome measurement, and to the parity check matrix can produce the candidate error and can also produce a respective fault probability for each column of the parity check matrix. In various instances, the candidate error can be a bitstring whose length is proportional to the total number of logical qubits and ancillary qubits involved in the QEC circuit and proportional to twice the total number of measurement cycles. In various cases, the candidate error can be considered as being a predicted, inferred, or estimated version of the underlying error that afflicted the QEC circuit. If a product between the parity check matrix and the candidate error is equal to the syndrome measurement, such prediction, inference, or estimation can be considered as being correct: that is, the underlying error that afflicted the QEC circuit can be concluded to be equal to the candidate error. In such case, the logical action of such underlying error can be obtained by multiplying the candidate error by the logical action matrix. On the other hand, if the product between the parity check matrix and the candidate error is not equal to the syndrome measurement, then the candidate error can be considered as not fully representing the underlying error that actually afflicted the QEC circuit. In such case, the column-wise fault probabilities can be utilized. In particular, during generation of the candidate error, belief propagation can compute a respective fault probability for each individual column of the parity check matrix, thereby classifying each individual column as either detecting a parity fault or as not detecting a parity fault. For instance, a fault probability closer to 1 (e.g., 100%) can indicate a greater likelihood of detecting a parity fault, whereas a fault probability closer to 0 (e.g., 0%) can indicate a lower likelihood of detecting a parity fault. In such situation, a fault probability closer to 0.5 (e.g., 50%) can indicate indecision, lack of confidence, or lack of reliability regarding fault/no-fault classification. Thus, for each column of the parity check matrix, a reliability or confidence value can be computed or derived from whatever fault probability corresponds to that column (e.g., reliability decreases as fault probability gets closer to 0.5).

In various embodiments, the decoder component of the computerized tool can, in response to the product between the candidate error and the parity check matrix not being equal to the syndrome measurement, identify the logical action wrought by whatever underlying error afflicted the QEC circuit. In various aspects, the decoder component can perform such identification via block-and-cycle feasibility checking.

In particular, there can be a full-sized linear system and a shrunken linear system, which equate respective coefficient-variable products to a residual syndrome measurement formed or derived from the candidate error. In various instances, the coefficients of the full-sized linear system can be the parity check matrix. In contrast, the coefficients of the shrunken linear system can be a subset of columns of the parity check matrix. As mentioned above, there can be a respective reliability value for each column of the parity check matrix. So, in some cases, the subset of columns can be any suitable number of columns chosen or selected from the parity check matrix in order of increasing reliability (e.g., starting from a least reliable column). In various aspects, the decoder component can choose or select the subset of columns one column at a time. In other aspects, the decoder component can instead choose or select the subset of columns more than one column at a time (e.g., in binary fashion where the number of columns is doubled at each selection iteration). No matter how the subset of columns is chosen or selected, the decoder component can evaluate the shrunken linear system one measurement cycle at a time.

For any given measurement cycle, the decoder component can form or create an even-more-shrunken linear system. The coefficients of such even-more-shrunken linear system can include whatever blocks of the parity check matrix correspond to the given measurement cycle, but such blocks can be restricted only to the selected or chosen subset of columns. Additionally, the coefficients of such even-more-shrunken linear system can include whatever blocks of the logical action matrix correspond to the given measurement cycle, where such blocks are also restricted only to the selected or chosen subset of columns (e.g., the parity check matrix and the logical action matrix can have the same total number of columns as each other, and so selection of an i-th column from the parity check matrix can correspond to selection of the i-th column from the logical action matrix). In some cases, the restricted blocks of the parity check matrix can be stacked on top of or otherwise with the restricted blocks of the logical action matrix. Furthermore, if the given measurement cycle is not a beginning or initial measurement cycle, the coefficients of the even-more-shrunken linear system can include an ansatz that was calculated by the decoder component during a preceding measurement cycle. Further still, the variables of such even-more-shrunken linear system can include a particular variable whose coefficients are formed by stacking: a zero matrix that is in line with the restricted blocks of the parity check matrix; on top of or otherwise with an identity matrix that is in line with the restricted blocks of the logical action matrix. In various aspects, the decoder component can attempt to solve (e.g., via Gaussian elimination) the even-more-shrunken linear system. That is, the decoder component can attempt to identify variable values that satisfy the even-more-shrunken linear system or that otherwise make the even-more-shrunken linear system true. If no such variable values exist, the even-more-shrunken linear system can be deemed infeasible, and the decoder component can respond to such infeasibility by adding yet more columns into the chosen or selected subset of columns of the parity check matrix and starting over from the beginning or initial measurement cycle. On the other hand, if such variable values do exist, the decoder component can identify such variable values, can calculate a new or updated ansatz using the restricted blocks of the parity check matrix and of the logical action matrix, and can proceed to a next or subsequent measurement cycle.

With this implementation, the particular variable can be considered as tracking, recording, or accumulating whatever error-induced logical actions are detected across all of the measurement cycles but are not accounted for by the candidate error. Thus, upon the even-more-shrunken linear system of a final or last measurement cycle being solved, the last computed value of the particular variable can be considered as representing a total amount of logical action that afflicted the QEC circuit but that was not accounted for or caused by the candidate error. In other words, that last value of the particular variable can be considered as being caused by the difference between the candidate error and the actual error that afflicted the QEC circuit. In various aspects, the decoder component can compute a net logical action for the QEC circuit, by adding that last value of the particular variable to a product between the logical action matrix and the candidate error. In this way, the net error-induced logical action of the QEC circuit can be computed or determined, without explicitly computing or determining the actual error that afflicted the QEC circuit.

In various embodiments, the correction component of the computerized tool can electronically perform or initiate any suitable tasks, based on the net logical action. As a non-limiting example, the correction component can correct or undo the net logical action, by applying a multiplicative inverse of the net logical action to the QEC circuit (e.g., to whatever quantum states are stored in the logical qubits of the quantum computer after or as a result of execution of the QEC circuit).

Various embodiments described herein can be employed to use hardware or software to solve problems that are highly technical in nature (e.g., to facilitate quantum error correction decoding via block-and-cycle feasibility checking), that are not abstract and that cannot be performed as a set of mental acts by a human. Further, some of the processes performed can be performed by a specialized computer (e.g., quantum computers made up of tangible qubits that can execute or implement quantum circuits).

In various aspects, some defined tasks associated with various embodiments described herein can include: accessing, by a device operatively coupled to a processor, a syndrome measurement and a parity check matrix associated with a quantum error correction circuit; and identifying, by the device, a logical action caused by an error afflicting the quantum error correction circuit, based on performing block-and-cycle feasibility checking on a first linear system derived from the syndrome measurement and from the parity check matrix. In some instances, such defined tasks can include: correcting, by the device, the error based on applying an inverse of the logical action to the quantum error correction circuit.

Neither the human mind nor a human with pen and paper can electronically access a QEC circuit, electronically identify an error-induced logical action afflicting the QEC circuit by checking a syndrome measurement using the blocks and cycles that make up a parity check matrix, and electronically undo the error-induced logical action by executing its inverse on, in, or with the QEC circuit. After all, a quantum computer is a specialized piece of computing hardware that utilizes physical qubits (e.g., superconducting qubits, such as transmons) to process information. Physical qubits cannot be implemented by the human mind or by a human with pen and paper. Moreover, a quantum circuit can be a sequence of quantum gates that can be executed on a quantum computer. Neither the human mind, nor a human with pen and paper, can execute quantum gates on physical qubits. Therefore, a computerized tool that can determine a logical action caused by an error in a QEC circuit and that can correct that logical action by executing its inverse is inherently computerized and cannot be implemented in any sensible, practicable, or reasonable way without computers.

In various instances, one or more embodiments described herein can integrate the herein-described teachings into a practical application. As mentioned above, QEC can involve performing pre-decoding (e.g., belief propagation) followed by decoding on a syndrome measurement. Existing techniques facilitate decoding via OSD. Rather than inverting an entirety of a parity check matrix (e.g., H) in order to solve a full-sized linear system (e.g., HΔe=s_{BP}), OSD involves inverting whichever columns of the parity check matrix were confidently determined to be faults (e.g., H_{faults}) in order to solve a smaller linear system (e.g., H_{faults}ê_{faults}=s_{BP}). Unfortunately, even with such smaller linear system, OSD possesses a large computational footprint (e.g., consumes significant amounts of runtime and memory space). That is, OSD can be considered as suffering from various technical problems.

Various embodiments described herein can address or otherwise ameliorate one or more of such technical problems. Indeed, various embodiments described herein can facilitate QEC decoding in less runtime or with less memory space than OSD is capable of facilitating. In particular, various embodiments described herein can achieve this via block-and-cycle feasibility checking; that is, by leveraging the fact that parity check matrices and logical action matrices are constructed or organized using blocks that are arranged according to syndrome measurement cycles. More specifically, there can be a full-sized linear system (e.g., HΔe=s_{BP}) from which a smaller linear system (e.g., H_{U}ê_{U}=s_{BP}) can be derived by choosing a subset of parity check matrix columns (e.g., chosen in order of increasing pre-decoder reliability). Rather than inverting that smaller linear system directly, various embodiments described herein can instead consider each cycle of that smaller linear system one at a time, creating an even-smaller linear system whose coefficients are formed by whichever column-restricted parity check matrix blocks and column-restricted logical action matrix blocks correspond to the instant cycle. As described herein, such even-smaller linear system can include a variable that is positioned or located additively in line with the column-restricted logical action matrix blocks, such that it cumulatively tracks or records whatever incremental amount of error-induced logical action (if any) is detected in the instant cycle. After a final cycle is considered by such block-and-cycle feasibility checking, the last or most recently computed value of that variable can be considered as representing a total amount of logical action that was missed, undetected, or otherwise not accounted for by pre-decoding. Thus, such last or most recently computed value of that variable can be added to a residual logical action derived from the pre-decoding, thereby yielding a net logical action that afflicted whatever QEC circuit is being evaluated. As the present inventors experimentally verified, computation of logical actions via block-and-cycle feasibility checking can consume significantly less runtime and memory space than OSD.

Additionally, it must be emphasized how counterintuitive and unexpected various embodiments described herein are. Indeed, various embodiments described herein can be considered as leveraging the fact that parity check matrices and logical action matrices are constructed or organized as blocks that are arranged by syndrome measurement cycle. OSD completely ignores such blocks. Indeed, such blocks are traditionally used only to construct such matrices and are not leveraged at all for analysis of such matrices. Furthermore, OSD can be considered as addressing syndrome measurement cycles all at once (e.g., via direct inversion of H_{faults}). It is indisputably unexpected or otherwise surprising that various embodiments described herein can save runtime and memory space not by addressing all syndrome measurement cycles simultaneously, but instead by addressing such syndrome measurement cycles one by one in turn (e.g., normally, it would instead be expected that runtime and memory space would be saved by addressing all cycles simultaneously). So, various embodiments described herein can be considered as cleverly or unusually utilizing the block-and-cycle constructions of parity check matrices and logical action matrices in order to perform QEC decoding in less time and with less memory space than OSD is capable of achieving.

For at least these reasons, various embodiments described herein provide concrete and tangible technical improvements or technical effects in the field of quantum error correction. Therefore, such embodiments certainly constitute useful and practical applications of computers.

It should be appreciated that the figures and the herein disclosure describe non-limiting examples of various embodiments. It should further be appreciated that the figures are not necessarily drawn to scale.

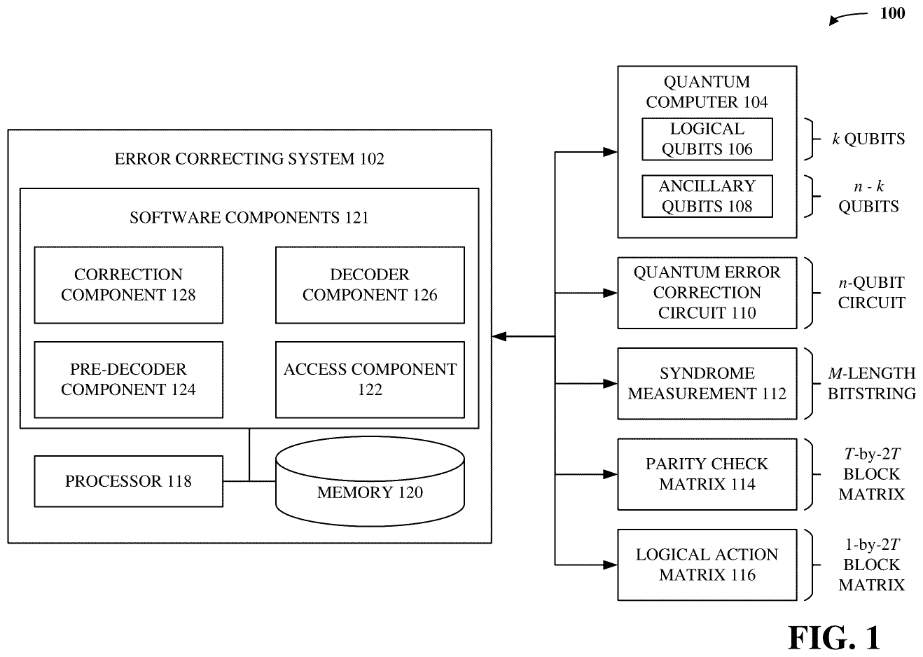

FIG. 1 illustrates a block diagram of an example, non-limiting system 100 that can facilitate quantum error correction decoding via block-and-cycle feasibility checking in accordance with one or more embodiments described herein. As shown, an error correcting system 102 can be electronically integrated, via any suitable wired or wireless electronic connections, with a quantum computer 104, with a quantum error correction circuit 110 (hereafter “QEC circuit 110”), with a syndrome measurement 112, with a parity check matrix 114, or with a logical action matrix 116.

In various embodiments, the quantum computer 104 can be any suitable quantum computing device or quantum computing hardware. In various aspects, the quantum computer 104 can have a set of logical qubits 106. In various instances, the set of logical qubits 106 can include k qubits for any suitable positive integer k. In various cases, the quantum computer 104 can have a set of ancillary qubits 108. In various aspects, the set of ancillary qubits 108 can include n−k qubits for any suitable positive integer n>k. Thus, the set of logical qubits 106 and the set of ancillary qubits 108 can collectively be considered as having or containing n qubits. In various instances, any of the set of logical qubits 106 or any of the set of ancillary qubits 108 can exhibit any suitable structure or architecture. As a non-limiting example, any of such qubits can exhibit a superconducting qubit architecture (e.g., such qubit can be constructed from any suitable number of Josephson junctions shunted by any suitable number of planar capacitor pads). As another non-limiting example, any of such qubits can exhibit a quantum dot architecture. As yet another non-limiting example, any of such qubits can exhibit a spin qubit architecture. In various aspects, different qubits of the set of logical qubits 106 or of the set of ancillary qubits 108 can exhibit the same or different structures or architectures as each other. Although not explicitly shown in FIG. 1, the quantum computer 104 can possess or otherwise be associated with any suitable hardware or software (e.g., real-time controllers implemented in field programmable gate arrays of the quantum computer 104) that can be used to initialize any of the set of logical qubits 106 or any of the set of ancillary qubits 108, or that can be used to perform any suitable quantum operations (e.g., quantum gates, qubit measurements, qubit idling) on the set of logical qubits 106 or on the set of ancillary qubits 108. Although also not explicitly shown in FIG. 1, it should be understood or otherwise appreciated that the quantum computer 104 can include any other qubits in addition to the set of logical qubits 106 and the set of ancillary qubits 108.

In various aspects, the QEC circuit 110 can be any suitable sequence of any suitable quantum gates (e.g., Hadamard gates, Phases gates, CNOT gates, Pauli-X gates, Pauli-Y gates, Pauli-Z gates) that can be executed in parallel or in series on the set of logical qubits 106 or on the set of ancillary qubits 108. Accordingly, in various instances, the QEC circuit 110 can be considered as being an n-qubit circuit (e.g., as being a circuit that can operate on n qubits, as being an n-order tensor product; as being a 2ⁿ×2ⁿ matrix). In some cases, the QEC circuit 110 can be considered as utilizing the set of logical qubits 106 in order to perform some desired quantum computation or combination of desired quantum computations, and the QEC circuit 110 can be considered as utilizing the set of ancillary qubits 108 in order to detect errors (e.g., bit-flip errors, phase-flip errors) that might afflict, occur within, or otherwise adversely affect that desired quantum computation or combination of desired quantum computations.

In various aspects, the syndrome measurement 112 can be a bitstring of length M, where M=Θ(nT)∈ [symbol] . Here, T can be any suitable integer representing how many total syndrome [symbol] measurement cycles are to be implemented for detecting errors in the QEC circuit 110. Additionally, Θ(*) can be considered as “Big Theta” notation which indicates exact order of growth (as opposed to “Big O” notation which indicates upper bound order of growth or “Big Omega” notation which indicates lower bound order of growth). Accordingly, the syndrome measurement 112 can be considered as a binary vector (e.g., a vector containing only 0s and 1s) whose length is proportional to the total number of qubits involved in the QEC circuit 110 and to the total number of syndrome measurement cycles that are desired to be implemented for the QEC circuit 110. As a non-limiting example, M=2nT. As another non-limiting example, M=3nT. No matter the specific dimensionality of the syndrome measurement 112, the syndrome measurement 112 can be obtained via execution of the QEC circuit 110 on the quantum computer 104. For instance, the quantum states of the set of logical qubits 106 and of the set of ancillary qubits 108 can be initialized in any suitable fashion (e.g., all initialized to |0 [symbol] or |1 [symbol] ), the QEC circuit 110 can be executed on the quantum computer 104 after such initialization, and tie syndrome measurement 112 can be generated via any suitable qubit measurement or readout operations that are performed on the quantum computer 104 during or after such execution.

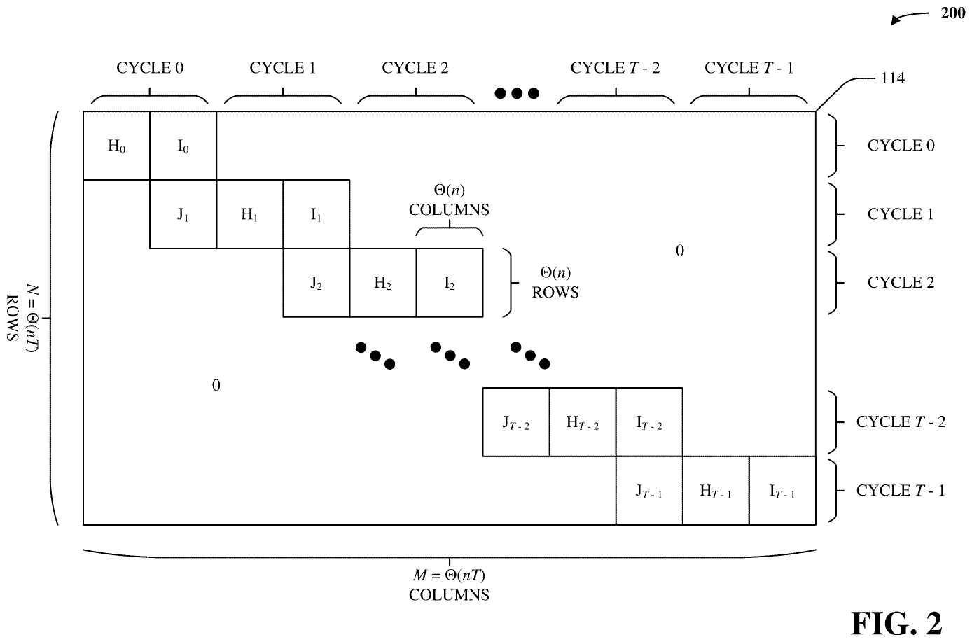

In various aspects, the parity check matrix 114 can be a binary block matrix of size T-by-2T that is known or deemed to detect errors within the QEC circuit 110. Non-limiting aspects are described with respect to FIG. 2.

FIG. 2 illustrates an example, non-limiting diagram 200 of the parity check matrix 114 in accordance with one or more embodiments described herein.

As shown, the parity check matrix 114 can be composed of blocks, each of which can be considered as a regular or repeating sub-matrix, which can be arranged in an almost-diagonal layout. In various aspects, the parity check matrix 114 can have a total of T block-rows, each of which can correspond to a respective syndrome measurement cycle. Similarly, the parity check matrix 114 can have a total of 2T block-columns, each consecutive pair of which can correspond to a respective syndrome measurement cycle.

More specifically, the blocks of the parity check matrix 114 can include three distinct types of blocks: an H-block; an I-block; and a J-block. Recall that an H-block can be a binary matrix (e.g., a matrix having only 0s and 1s) that is designed or configured to detect memory errors (as opposed to measurement errors) within a given syndrome measurement cycle, and recall that all H-blocks in the parity check matrix 114 can be equal to each other. Additionally, recall that an I-block can be a binary matrix that is designed or configured to detect measurement errors (as opposed to memory errors) within the given syndrome measurement cycle, and recall that all I-blocks in the parity check matrix 114 can be equal to each other. Lastly, recall that a J-block can be a binary matrix that is designed or configured to detect measurement errors (as opposed to memory errors) that are propagated from a previous or preceding syndrome measurement cycle, and recall that all J-blocks in the parity check matrix 114 can be equal to each other. In various aspects, each H-block, I-block, and J-block can be composed or made up of Θ(n) rows and Θ(n) columns. That is, the number of rows in each H-block, I-block, and J-block can be proportional to n, and the number of columns in each H-block, I-block, and J-block can also be proportional to n. As a non-limiting example, each I-block and J-block can be an n-by-n matrix, and each H-block can be an n-by-2n matrix. Note that: H-blocks, I-blocks, and J-blocks can all be made up of the same number of rows as each other; I-blocks and J-blocks can all be made up of the same number of columns as each other; and H-blocks can be made up of the same or different numbers of columns as I-blocks and J-blocks. As a non-limiting example, when the syndrome measurement 112 is generated by the Gross code, each I-block and J-block can be a 72-by-72 identity matrix, and each H-block can be a 72-by-144 Gross check matrix.

In various aspects, the parity check matrix 114 can have or possess a total of T block-rows. As a non-limiting example, a topmost block-row of the parity check matrix 114 can correspond to a 0-th syndrome measurement cycle (denoted “cycle 0”). As another non-limiting example, a second-from-the-top block-row of the parity check matrix 114 can correspond to a 1-st syndrome measurement cycle (denoted “cycle 1”). As yet another non-limiting example, a third-from-the-top block-row of the parity check matrix 114 can correspond to a 2-nd syndrome measurement cycle (denoted “cycle 2”). As even another non-limiting example, a second-from-the-bottom block-row of the parity check matrix 114 can correspond to a (T−2)-th syndrome measurement cycle (denoted “cycle T−2”). As still another non-limiting example, a bottommost block-row of the parity check matrix 114 can correspond to a (T−1)-th syndrome measurement cycle (denoted “cycle T−1”).

In various instances, the parity check matrix 114 can have or possess a total of 2T block-columns. As a non-limiting example, a leftmost pair of block-columns of the parity check matrix 114 can correspond to the 0-th syndrome measurement cycle. As another non-limiting example, a second-from-the-leftmost pair of block-columns of the parity check matrix 114 can correspond to the 1-st syndrome measurement cycle. As yet another non-limiting example, a third-from-the-leftmost pair of block-columns of the parity check matrix 114 can correspond to the 2-nd syndrome measurement cycle. As even another non-limiting example, a second-from-the-rightmost pair of block-columns of the parity check matrix 114 can correspond to the (T−2)-th syndrome measurement cycle. As still another non-limiting example, a rightmost pair of block-columns of the parity check matrix 114 can correspond to the (T−1)-th syndrome measurement cycle.

In any case, the H-blocks, I-blocks, and J-blocks of the parity check matrix 114 can be arranged in an almost-diagonal layout in order of syndrome measurement cycle. As a non-limiting example, the cycle 0 block-row of the parity check matrix 114 can contain an H-block denoted H₀ and an I-block denoted I₀, where H₀ can be located to the left of I₀, where H₀ can detect memory errors that occur in cycle 0, and where I₀ can detect measurement errors that occur in cycle 0. Because there can be no cycle that precedes cycle 0, there can be no J-block in the cycle 0 block-row. As another non-limiting example, the cycle 1 block-row of the parity check matrix 114 can contain an H-block denoted H₁, an I-block denoted h₁, and a J-block denoted J₁, where H₁ can be located to the left of h₁, where Jᵢ can be located to the left of H₁, where H₁ can detect memory errors that occur in cycle 1, where I₁ can detect measurement errors that occur in cycle 1, and where Jᵢ can detect measurement errors that occurred in cycle 0 and that were propagated to cycle 1. Note how J₁ can be located below I₀. As yet another non-limiting example, the cycle 2 block-row of the parity check matrix 114 can contain an H-block denoted H₂, an I-block denoted I₂, and a J-block denoted J₂, where H₂ can be located to the left of I₂, where J₂ can be located to the left of H₂, where H₂ can detect memory errors that occur in cycle 2, where I₂ can detect measurement errors that occur in cycle 2, and where J₂ can detect measurement errors that occurred in cycle 1 and that were propagated to cycle 2. Note how J₂ can be located below h₁. As still another non-limiting example, the cycle T−1 block-row of the parity check matrix 114 can contain an H-block denoted H_{T-1}, an I-block denoted I_{T-1}, and a J-block denoted J_{T-1}, where H_{T-1} can be located to the left of I_{T-1}, where J_{T-1} can be located to the left of H_{T-1} and below an I-block denoted I_{T-2}, where H_{T-1} can detect memory errors that occur in cycle T−1, where I_{T-1} can detect measurement errors that occur in cycle T−1, and where J_{T-1} can detect measurement errors that occurred in cycle T−2 and that were propagated to cycle T−1. Note that the parity check matrix 114 can contain all zeros outside of the H-blocks, I-blocks, and J-blocks.

Because each block of the parity check matrix 114 can be made up of Θ(n) rows, and because the parity check matrix 114 can be made up of T block-rows, the parity check matrix 114 can have a total of N=Θ(nT)∈ [symbol] rows (e.g., in some instances, N=nT). Likewise, because each block of the parity check matrix 114 can be made up of Θ(n) columns, and because the parity check matrix 114 can be made up of 2T block-columns, the parity check matrix 114 can have a total of M=Θ(nT)ε [symbol] columns where M>N (e.g., in some instances, M=2nT; in other instances, M=3nT).

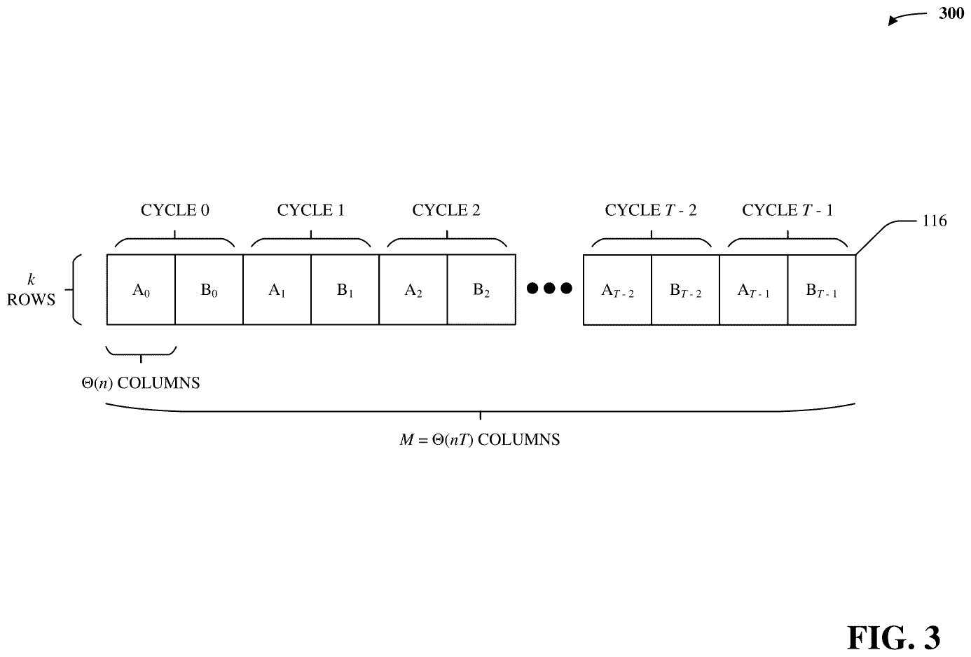

Referring back to FIG. 1, the logical action matrix 116 can be a binary block matrix of size 1-by-2T that is known or deemed to represent quantum state transformations caused or enacted by errors detected by the parity check matrix 114. Non-limiting aspects are described with respect to FIG. 3.

FIG. 3 illustrates an example, non-limiting diagram 300 of the logical action matrix 116 in accordance with one or more embodiments described herein.

As shown, the logical action matrix 116 can be composed of blocks, each of which can be considered as a regular or repeating sub-matrix, which can be arranged into a single chain, string, or strand. In various aspects, the logical action matrix 116 can have a single block-row. In contrast, the logical action matrix 116 can have a total of 2T block-columns, each consecutive pair of which can correspond to a respective syndrome measurement cycle.

More specifically, the blocks of the logical action matrix 116 can include two distinct types of blocks: a A-block; and a B-block. Recall that an A-block can be a binary matrix that is designed or configured to represent a quantum state transformation that is caused by a memory error (as opposed to being caused by a measurement errors) within a given syndrome measurement cycle, and recall that all A-blocks in the logical action matrix 116 can be equal to each other. Additionally, recall that a B-block can be a binary matrix that is designed or configured to represent a quantum state transformation that is caused by a measurement error (as opposed to being caused by a memory error) within the given syndrome measurement cycle, and recall that all B-blocks in the logical action matrix 116 can be equal to each other. In various aspects, each A-block and B-block can be composed or made up of k rows and Θ(n) columns. Thus, the number of columns in each A-block and B-block can be proportional to n. As a non-limiting example, each A-block can be made up of the same number of columns as each H-block of the parity check matrix 114, and each B-block can be made up of the same number of columns as each I-block (and thus as each J-block) of the parity check matrix 114.

In various aspects, the logical action matrix 116 can have or possess a total of 2T block-columns. As a non-limiting example, a leftmost pair of block-columns of the logical action matrix 116 can correspond to the cycle 0. As another non-limiting example, a second-from-the-leftmost pair of block-columns of the logical action matrix 116 can correspond to the cycle 1. As yet another non-limiting example, a third-from-the-leftmost pair of block-columns of the logical action matrix 116 can correspond to the cycle 2. As even another non-limiting example, a second-from-the-rightmost pair of block-columns of the logical action matrix 116 can correspond to the cycle T−2. As still another non-limiting example, a rightmost pair of block-columns of the logical action matrix 116 can correspond to the cycle T−1.

In any case, the A-blocks and B-blocks of the logical action matrix 116 can be arranged in a single chain or string in order of syndrome measurement cycle. As a non-limiting example, the cycle 0 block-columns of the logical action matrix 116 can contain an A-block denoted A₀ and a B-block denoted B₀, where A₀ can be located to the left of B₀, where A₀ can represent whatever quantum transformation is caused by memory errors that occur in cycle 0, and where B₀ can represent whatever quantum transformation is caused by measurement errors that occur in cycle 0 or that are propagated to cycle 1. As another non-limiting example, the cycle 1 block-columns of the logical action matrix 116 can contain an A-block denoted A₁ and a B-block denoted B₁, where A₁ can be located to the left of B₁ and to the right of B₀, where A₁ can represent whatever quantum transformation is caused by memory errors that occur in cycle 1, and where B₁ can represent whatever quantum transformation is caused by measurement errors that occur in cycle 1 or that are propagated to cycle 2. As yet another non-limiting example, the cycle 2 block-columns of the logical action matrix 116 can contain an A-block denoted A₂ and a B-block denoted B₂, where A₂ can be located to the left of B₂ and to the right of B₁, where A₂ can represent whatever quantum transformation is caused by memory errors that occur in cycle 2, and where B₂ can represent whatever quantum transformation is caused by measurement errors that occur in cycle 2 or that are propagated to a cycle 3. As even another non-limiting example, the cycle T−1 block-columns of the logical action matrix 116 can contain an A-block denoted A_{T-1} and a B-block denoted B_{T-1}, where A_{T-1} can be located to the left of B_{T-1} and to the right of a B-block denoted B_{T-2}, where A_{T-1} can represent whatever quantum transformation is caused by memory errors that occur in cycle T−1, and where B_{T-1} can represent whatever quantum transformation is caused by measurement errors that occur in cycle T−1.

Because each A-block of the logical action matrix 116 can be made up of the same number of columns as each H-block of the parity check matrix 114, and because each B-block of the logical action matrix 116 can be made up of the same number of columns as each I-block (and thus each J-block) of the parity check matrix 114, the logical action matrix 116 can have a total of M columns (same number of columns as the parity check matrix 114).

It should be understood or otherwise appreciated that, when given the QEC circuit 110, the parity check matrix 114 and the logical action matrix 116 can be determined or constructed (e.g., if the QEC circuit 110 is known, then it can likewise be known which H-blocks, I-blocks, J-blocks, A-blocks, and B-blocks are appropriate or suitable to use for quantum error correction purposes).

Note that, given the above descriptions of the parity check matrix 114 and the logical action matrix 116, they can be respectively mathematically denoted as H∈{0,1}^{N×M} (here “H” is referring to the entirety of the parity check matrix 114, which is not to be confused with an H-block inside of the parity check matrix 114) and L∈{0,1}^{k×M}. Likewise, the syndrome measurement 112 can be mathematically denoted as s∈{0,1}^{M}.

Referring back to FIG. 1, it can be desired to determine how errors that might have occurred during execution of the QEC circuit 110 affected or changed the quantum states of the set of logical qubits 106. As described herein, the error correcting system 102 can facilitate such determination.

In various embodiments, the error correcting system 102 can include a processor 118 (e.g., computer processing unit, microprocessor) and a non-transitory computer-readable memory 120 that is operably connected or coupled to the processor 118. The memory 120 can store computer-executable instructions which, upon execution by the processor 118, can cause the processor 118 or other components of the error correcting system 102 (e.g., access component 122, pre-decoder component 124, decoder component 126, correction component 128) to perform one or more acts. In various embodiments, the memory 120 can store computer-executable components (e.g., access component 122, pre-decoder component 124, decoder component 126, correction component 128), and the processor 118 can execute the computer-executable components.

In various embodiments, the error correcting system 102 can include an access component 122. In various aspects, the access component 122 can electronically access, in any suitable fashion, the quantum computer 104. That is, the access component 122 can establish any suitable type of electronic communication with the quantum computer 104, such that the error correcting system 102 can initialize, electronically activate (e.g., power-up), electronically deactivate (e.g., power-down), or otherwise electronically control the quantum computer 104. Furthermore, in various instances, the access component 122 can electronically receive, retrieve, obtain, import, or otherwise access, from any suitable data structures or from any suitable computing devices, the QEC circuit 110, the syndrome measurement 112, the parity check matrix 114, or the logical action matrix 116. Accordingly, the access component 122 can be considered as proxy or conduit through which any other component of the error correcting system 102 can electronically interact with or otherwise manipulate the quantum computer 104, the QEC circuit 110, the syndrome measurement 112, the parity check matrix 114, or the logical action matrix 116.

In various embodiments, the error correcting system 102 can include a pre-decoder component 124. In various aspects, the pre-decoder component 124 can, as described herein, generate a candidate error and a set of column-wise reliabilities based on the syndrome measurement 112 and the parity check matrix 114.

In various embodiments, the error correcting system 102 can include a decoder component 126. In various instances, the decoder component 126 can, as described herein, determine a logical action that is caused by an error afflicting the QEC circuit 110, based on the candidate error, the set of column-wise reliabilities, and a block-and-cycle feasibility checking algorithm.

In various embodiments, the error correcting system 102 can include a correction component 128. In various cases, the correction component 128 can, as described herein, correct the logical action, by applying its inverse to the QEC circuit 110.

Note that, in various instances, the access component 122, the pre-decoder component 124, the decoder component 126, and the correction component 128 can collectively be considered as being one or more software components 121 of the error correcting system 102. In various aspects, it should be appreciated that the one or more software components 121 are described primarily herein as comprising four components (e.g., the access component 122, the pre-decoder component 124, the decoder component 126, and the correction component 128) for ease of explanation and illustration. However, the one or more software components 121 are not limited to being implemented as exactly such four components in every embodiment. Indeed, in some embodiments, the functionalities described herein of such four components can be combined in any suitable fashions, so as to be implemented in or by fewer than four components (e.g., in some cases, a single component can perform all of the functionalities that are described herein with respect to the access component 122, the pre-decoder component 124, the decoder component 126, and the correction component 128). In other embodiments, the functionalities described herein of such four components can instead be distributed, separated, split, or fragmented in any suitable fashions, so as to be implemented in or by more than four components (e.g., two or more components can facilitate the functionalities that are performable by the access component 122; two or more components can facilitate the functionalities that are performable by the pre-decoder component 124; two or more components can facilitate the functionalities that are performable by the decoder component 126; two or more components can facilitate the functionalities that are performable by the correction component 128).

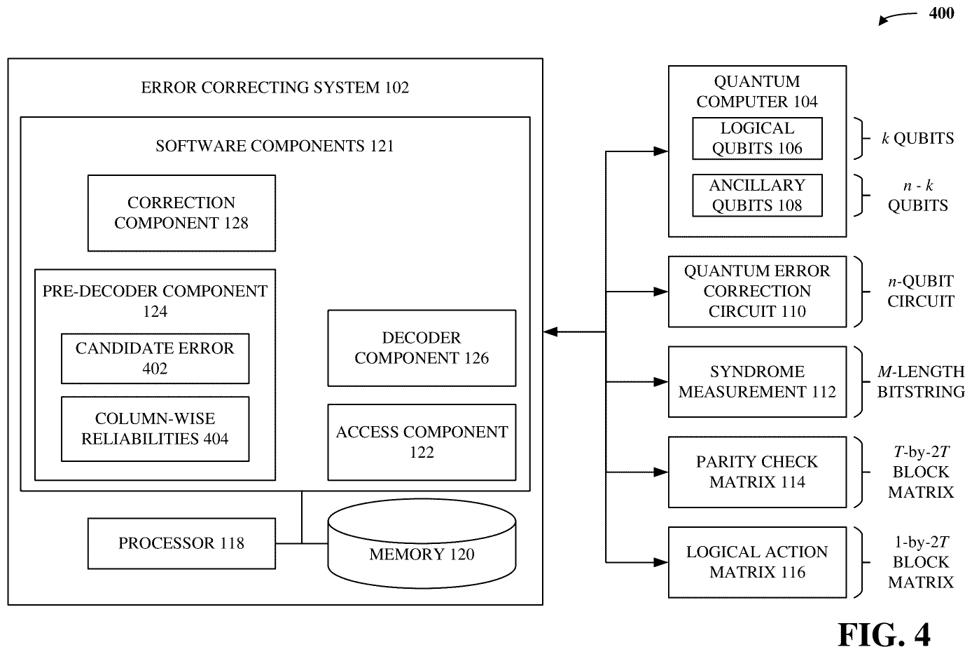

FIG. 4 illustrates a block diagram of an example, non-limiting system 400 including a candidate error and a plurality of column-wise reliabilities that can facilitate quantum error correction decoding via block-and-cycle feasibility checking in accordance with one or more embodiments described herein. As shown, the system 400 can, in some cases, include the same components as the system 100, and can further include a candidate error 402 and a plurality of column-wise reliabilities 404.

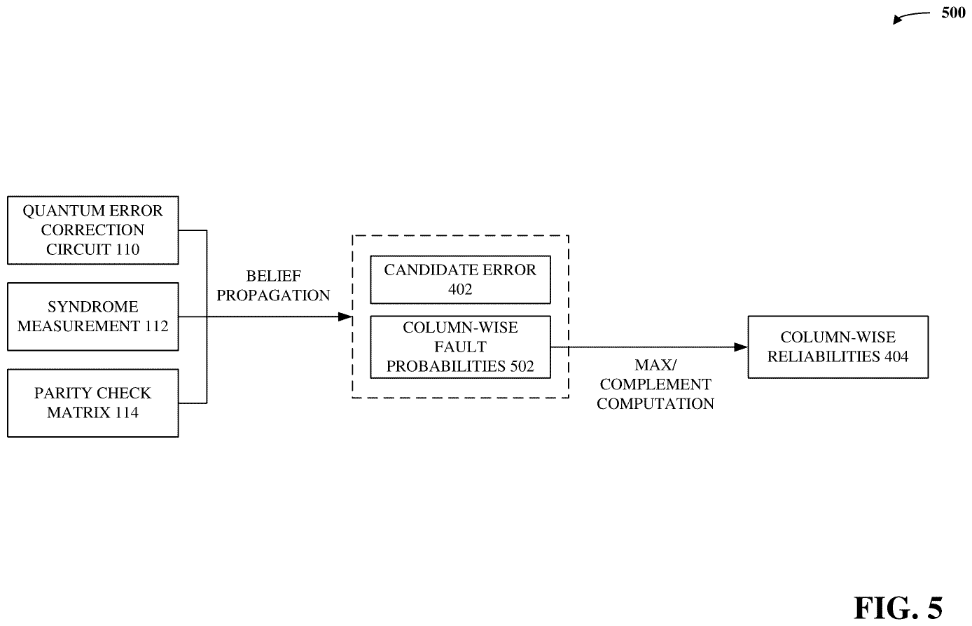

In various embodiments, the pre-decoder component 124 can electronically generate the candidate error 402 and the plurality of column-wise reliabilities 404, based on the QEC circuit 110, the syndrome measurement 112, and the parity check matrix 114. Non-limiting aspects are described with respect to FIG. 5.

FIG. 5 illustrates an example, non-limiting block diagram 500 showing how the candidate error 402 and the plurality of column-wise reliabilities 404 can be generated in accordance with one or more embodiments described herein.

In various embodiments, the pre-decoder component 124 can perform, on the QEC circuit 110, on the syndrome measurement 112, and on the parity check matrix 114, any suitable type of pre-decoding algorithm or technique that is appropriate for use in quantum error correction. As a non-limiting example, such pre-decoding algorithm or technique can be belief propagation. However, in other cases, such pre-decoding algorithm or technique can be any other suitable type of soft-decision protocol for low-density parity check codes. For ease of explanation and illustration, the remainder of the herein disclosure will assume that belief propagation is applied by the pre-decoder component 124.

In any case, belief propagation (or whatever other pre-decoding algorithm) can be considered as attempting to identify or determine what error (if any) actually occurred during execution of the QEC circuit 110 on the quantum computer 104. Such actual error can be denoted as e∈{0,1}^{M}. More specifically, belief propagation can be considered as taking three input arguments and as producing two output arguments using those three input arguments. The three input arguments can include: the QEC circuit 110; the syndrome measurement 112; and the parity check matrix 114. The two output arguments can include the candidate error 402 and a plurality of column-wise fault probabilities 502.

In various aspects, the candidate error 402 can be considered as an approximation or estimation of the actual error e. Thus, the candidate error 402 can have the same size or dimensionality as the actual error e. That is, the candidate error 402 can be a bitstring of length M. Mathematically, the candidate error 402 can be denoted as e_{BP}∈{0,1}^{M}. In any case, the candidate error 402 can represent or be whatever error that belief propagation infers or predicts occurred during the execution of the QEC circuit 110 on the quantum computer 104. In some instances, the candidate error 402 can be equal to the actual error e. Indeed, such equality can be concluded or assumed, in response to a product between the candidate error 402 and the parity check matrix 114 being equal to the syndrome measurement 112 (e.g., it can be concluded that e_{BP}=e if s=He_{BP}). However, in other instances, the candidate error 402 can be unequal to the actual error e. Indeed, such inequality can be concluded or assumed, in response to the product between the candidate error 402 and the parity check matrix 114 not being equal to the syndrome measurement 112 (e.g., it can be concluded that e_{BP}≠e if s≠He_{BP}).

In various aspects, the plurality of column-wise fault probabilities 502 can respectively correspond (e.g., in one-to-one fashion) to the columns of the parity check matrix 114. Because the parity check matrix 114 can have a total of M columns, the plurality of column-wise fault probabilities 502 can thus have a total of M fault probabilities, one per column (hence the term “column-wise”). In various instances, each of the plurality of column-wise fault probabilities 502 can be a real-valued scalar ranging from 0 to 1 whose magnitude indicates how likely it is that a respective column of the parity check matrix 114 has detected a fault (e.g., phase-flip fault, bit-flip fault) in the QEC circuit 110. Accordingly, magnitudes closer to 1 can correspond to columns that are confidently determined by belief propagation to have detected faults. In contrast, magnitudes closer to 0 can correspond to columns that are confidently determined by belief propagation to have not detected faults. Furthermore, magnitudes closer to 0.5 can correspond to columns that are unconfidently determined by belief propagation to have detected faults or to have not detected faults.

In various cases, the pre-decoder component 124 can convert the plurality of column-wise fault probabilities 502 into the plurality of column-wise reliabilities 404. In various aspects, the plurality of column-wise reliabilities 404 can respectively correspond (e.g., in one-to-one fashion) to the plurality of column-wise fault probabilities 502 and thus to the columns of the parity check matrix 114. Because the parity check matrix 114 can have a total of M columns, the plurality of column-wise reliabilities 404 can thus have a total of M reliabilities, one per column. In various instances, each of the plurality of column-wise reliabilities 404 can be a real-valued scalar ranging from 0 to 1 whose magnitude indicates how much confidence belief propagation had when classifying a respective column of the parity check matrix 114 as having detected a fault or as not having detected a fault. For any given column of the parity check matrix 114, the pre-decoder component 124 can compute a reliability for that given column based on whatever fault probability corresponds to that given column. As a non-limiting example, the reliability of the given column can be equal to the maximum of: the fault probability of that given column; or the complement of the fault probability of that given column (e.g., 1 minus that fault probability). With such max/complement formulation, the reliability of the given column increases in magnitude as the fault probability of the given column gets closer to 1 or instead closer to 0, and the reliability of the given column decreases in magnitude as the fault probability of the given column gets closer to 0.5. However, in other cases, the reliability of the given column can instead be equal to any other suitable function of the fault probability of the given column.

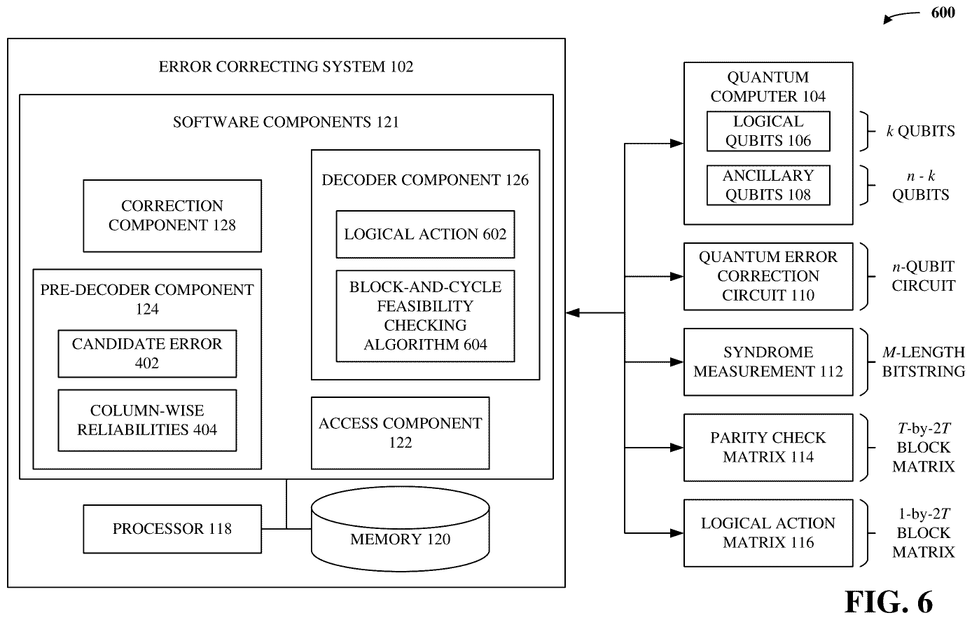

FIG. 6 illustrates a block diagram of an example, non-limiting system 600 including a logical action and a block-and-cycle feasibility checking algorithm that can facilitate quantum error correction decoding via block-and-cycle feasibility checking in accordance with one or more embodiments described herein. As shown, the system 600 can, in some cases, have the same components as the system 400, and can further have a logical action 602 and a block-and-cycle feasibility checking algorithm 604.

In various embodiments, the decoder component 126 can refrain from taking action, in response to the product between the parity check matrix 114 and the candidate error 402 being equal to the syndrome measurement 112. After all, in such situation, the candidate error 402 can be considered as being equal to the actual error e that afflicted the QEC circuit 110. In such case, the correction component 128 can compute an inverse of a product between the logical action matrix 116 and the candidate error 402, and the correction component 128 can apply such inverse to the QEC circuit 110 (e.g., can perform whatever quantum transformation is represented by such inverse to whatever quantum states that the set of logical qubits 106 have as a result of the QEC circuit 110). However, the decoder component 126 can instead identify the logical action 602 by leveraging the block-and-cycle feasibility checking algorithm 604, in response to the product between the parity check matrix 114 and the candidate error 402 not being equal to the syndrome measurement 112.

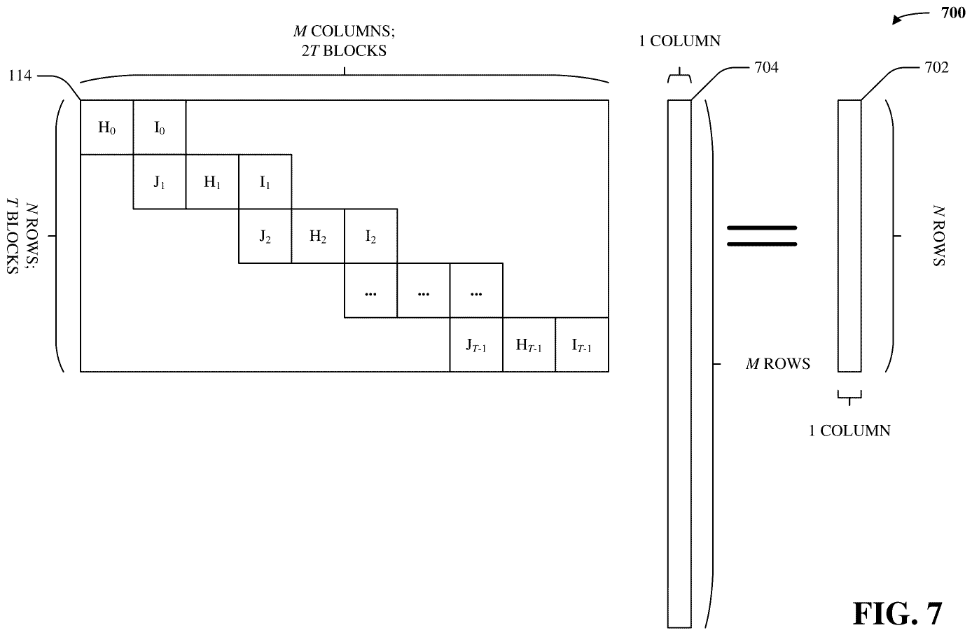

In various cases, the logical action 602 can be considered as a bitstring of length k that represents how the actual error e interfered with or changed the quantum states of the set of logical qubits 106, and the block-and-cycle feasibility checking algorithm 604 can be considered as quickly or efficiently computing the logical action 602 by leveraging the fact that the parity check matrix 114 and the logical action matrix 116 are constructed from blocks that are organized according to the syndrome measurement cycles. Non-limiting aspects are described with respect to FIGS. 7-12.

FIGS. 7-12 illustrate example, non-limiting diagrams showing how the logical action 602 can be identified via the block-and-cycle feasibility checking algorithm 604 in accordance with one or more embodiments described herein.

First, consider FIG. 7, which shows a full-sized linear system 700. The full-sized linear system 700 can be derived from the syndrome measurement 112, the parity check matrix 114, and the candidate error 402. Specifically, a residual syndrome 702, which can be denoted as s_{BP}∈{0,1}^{N} can be equal to a sum of: a product between the parity check matrix 114 and the candidate error 402; and the syndrome measurement 112. That is, s_{BP}=s+He_{BP}. Moreover, the full-sized linear system 700 can equate the residual syndrome 702 to a product between the parity check matrix 114 and a variable vector 704. In various cases, the variable vector 704, which can be not yet known, can be denoted as Δe∈{0,1}^{M}, and a sum between the variable vector 704 and the candidate error 402 can yield the actual error e (which is also not yet known). That is, e=e_{BP}+Δe.

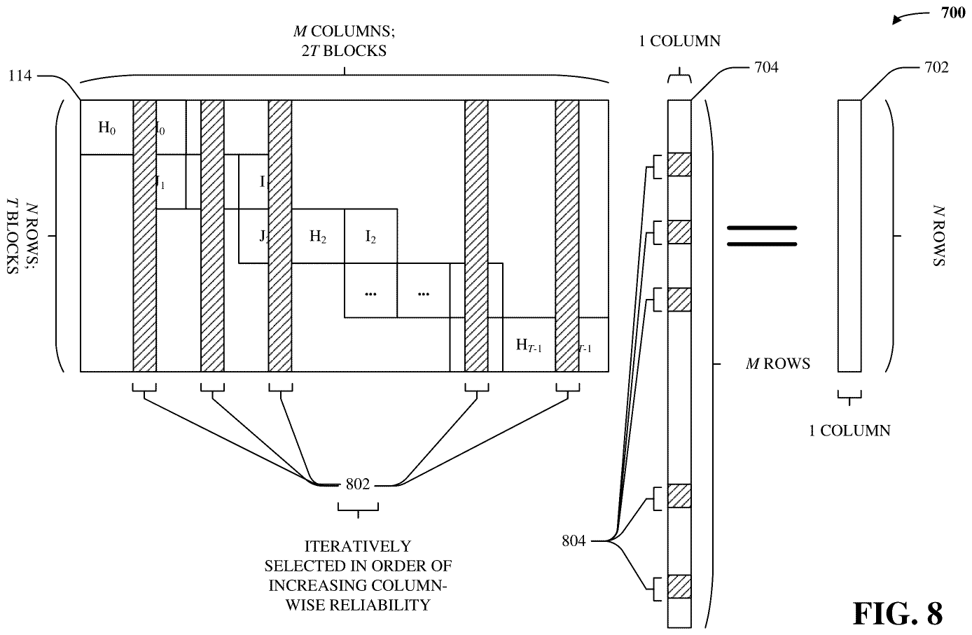

Next, consider FIG. 8. In various aspects, the decoder component 126 can iteratively select or choose a subset of columns 802 from the parity check matrix 114. In various instances, the subset of columns 802 can be denoted as U. In various cases, the decoder component 126 can select or choose the subset of columns 802 based on the plurality of column-wise reliabilities 404. As a non-limiting example, the decoder component 126 can select or choose the subset of columns 802 in order of increasing reliability (e.g., starting from a least reliable column). In some situations, the decoder component 126 can select or choose the subset of columns 802 one column per selection iteration (e.g., each time that the decoder component 126 is to make a selection from the parity check matrix 114, it can select only one column to add into the subset of columns 802). In other situations, however, the decoder component 126 can instead select or choose the subset of columns 802 more than one column per selection iteration (e.g., each time that the decoder component 126 is to make a selection from the parity check matrix 114, it can select multiple columns to add into the subset of columns 802). For instance, in some cases, the decoder component 126 can select or choose the subset of columns 802 in a binary search fashion, such that the decoder component 126 doubles the size of the subset of columns 802 at each selection iteration. In any case, the columns of the parity check matrix 114 can be considered as respectively corresponding to the rows of the variable vector 704. Thus, the subset of columns 802 of the parity check matrix 114 can be considered as respectively corresponding to a subset of rows 804 of the variable vector 704. As a non-limiting example, if a v-th column from the parity check matrix 114 is included in the subset of columns 802 for any suitable positive integer v≤M, then a v-th row from the variable vector 704 can likewise be included in the subset of rows 804.

Note that the subset of columns 802 can be chosen or selected in any suitable fashion and is thus not limited only to selection in order of increasing reliability. However, the present inventors found that selection in order of increasing reliability is beneficial or advantageous with respect to minimizing computational footprint. After all, such selection regime can be considered as the decoder component 126 focusing only the columns of the parity check matrix 114 that belief propagation was unable to confidently evaluate. In contrast, selection of high-reliability columns (e.g., reliably classified faults or reliably classified no-faults) of the parity check matrix 114 can be considered as the decoder component 126 re-performing or re-doing analytical work that was already confidently done by belief propagation. Thus, selection of high-reliability columns can undesirably increase computational footprint.

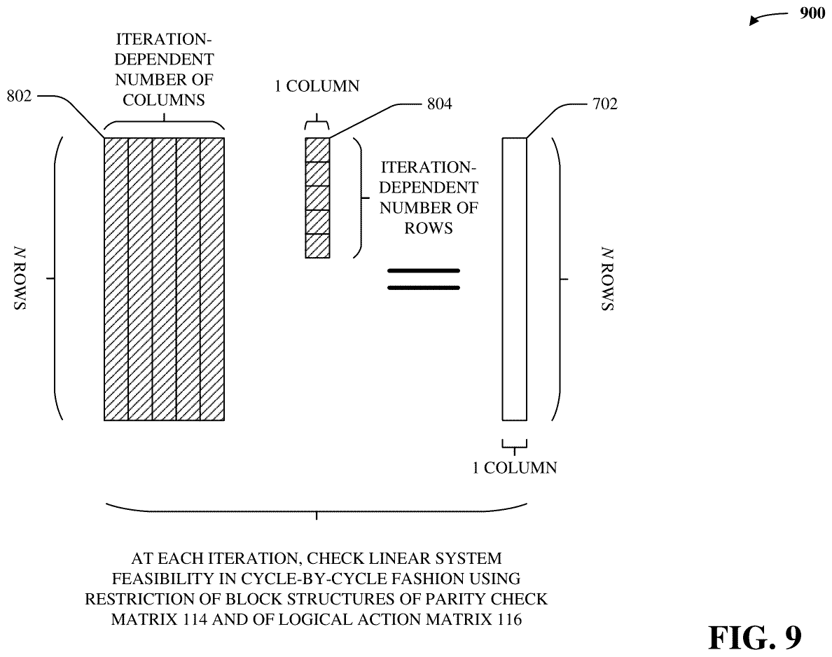

Now, consider FIG. 9, which shows a shrunken linear system 900. The shrunken linear system 900 can equate the residual syndrome 702 to a product between: a new matrix formed by the subset of columns 802; and a new variable vector formed by the subset of rows 804. Note that the number of columns in the new matrix and the number of rows in the new variable vector can depend upon the current or most recent selection iteration (e.g., since the sizes of the subset of columns 802 and of the subset of rows 804 change with each selection iteration). In various aspects, at each iteration (e.g., after each time or instance that the subset of columns 802 is expanded), the decoder component 126 can check the shrunken linear system 900 for feasibility or solvability. However, rather than doing so by inverting the new matrix formed by the subset of columns 802, the decoder component 126 can instead do so by executing the block-and-cycle feasibility checking algorithm 604 (e.g., can do so in cycle-by-cycle fashion using column-wise restriction of the block structures that are exhibited by the parity check matrix 114 and by the logical action matrix 116). If the shrunken linear system 900 is found to be infeasible or unsolvable, the decoder component 126 can increase the size of the subset of columns 802 in order of increasing reliability and re-run the block-and-cycle feasibility checking algorithm 604. If the shrunken linear system 900 is instead found to be feasible or solvable, the decoder component 126 can derive the logical action 602 from the outputs produced by the block-and-cycle feasibility checking algorithm 604.

In some situations, the decoder component 126 can, in response to finding the shrunken linear system 900 feasible or solvable, refrain from computing the logical action 602 and can instead remove one or more columns from the subset of columns 802 if the shrunken linear system 900 would still be feasible or solvable after such removal. In this way, the decoder component 126 can refrain from computing the logical action 602 until the subset of columns 802 is minimized (e.g., has as few columns as possible) while still allowing the shrunken linear system 800 to be feasible or solvable. This can help to further reduce a computational footprint associated with generation of the logical action 602.

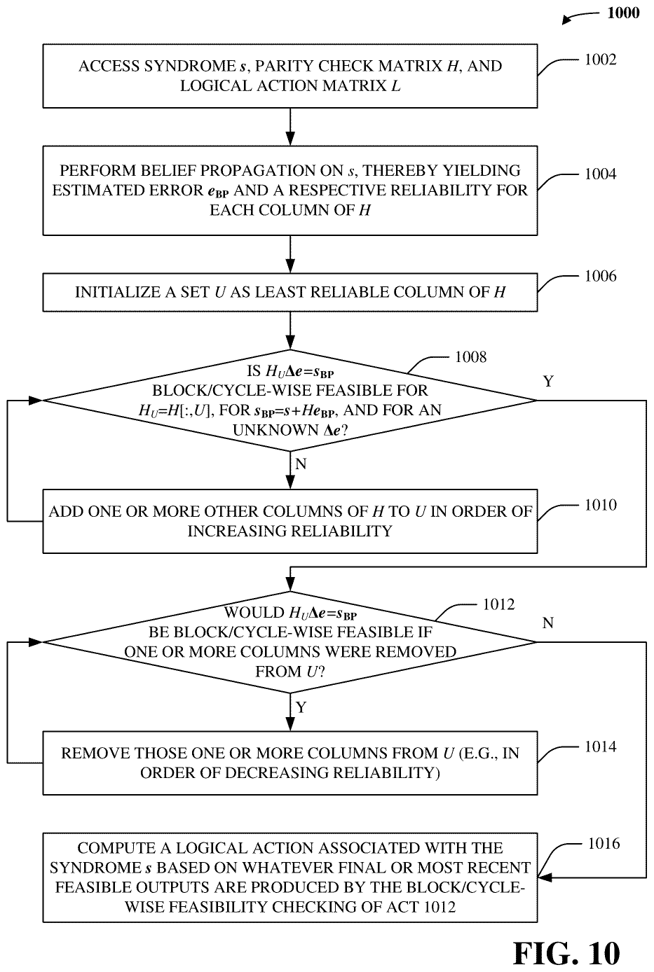

FIG. 10 illustrates a non-limiting, example flow diagram of a computer-implemented method 1000 that can be implemented by the error correcting system 102.

In various embodiments, act 1002 can include accessing (e.g., via 120) a syndrome s (e.g., 112), a parity check matrix H (e.g., 114), and a logical action matrix L (e.g., 116).

In various aspects, act 1004 can include performing (e.g., via 124) belief propagation on s, thereby yielding an estimated error e_{BP} (e.g., 402) and a respective reliability for each column of H (e.g., 404).

In various instances, act 1006 can include initializing (e.g., via 126) a set U (e.g., 802) as a least reliable column of H.

In various cases, act 1008 can include determining (e.g., via 126) whether H_{U}Δe=s_{BP} is a block-and-cycle-wise feasible linear system, where H_{U}=H[:, U] (e.g., H_{U} is H restricted or projected onto U), where s_{BP} is a residual syndrome (e.g., 702) given by s_{BP}=s+He_{BP}, and where Δe is an unknown variable vector (e.g., 704). In various aspects, such determination can be made via execution of the block-and-cycle feasibility checking algorithm 604. If H_{U}Δe=s_{BP} is not block-and-cycle-wise feasible, then the computer-implemented method 1000 can proceed to act 1010. If H_{U}Δe=s_{BP} is block-and-cycle-wise feasible, then the computer-implemented method 1000 can instead proceed to act 1012.

In various instances, act 1010 can include adding (e.g., via 126) one or more other columns of H to U in order of increasing reliability. The computer-implemented method 1000 can then proceed back to act 1008.

In various cases, act 1012 can include determining (e.g., via 126) whether H_{U}Δe=s_{BP} would be a block-and-cycle-wise feasible linear system if one or more columns were removed from U in order of decreasing reliability. As above, such determination can be made via execution of the block-and-cycle feasibility checking algorithm 604. If H_{U}Δe=s_{BP} would still be block-and-cycle-wise feasible after such removal, then the computer-implemented method 1000 can proceed to act 1014. If H_{U}Δe=s_{BP} would not be block-and-cycle-wise feasible after such removal, then the computer-implemented method 1000 can instead proceed to act 1016.

In various aspects, act 1014 can include removing (e.g., via 126) those one or more columns from U. The computer-implemented method 1000 can then proceed back to act 1012.

In various instances, act 1016 can include computing (e.g., via 126) a logical action (e.g., 602) associated with s, based on whatever final or most recent outputs are produced by the block-and-cycle-wise feasibility checking of act 1012.

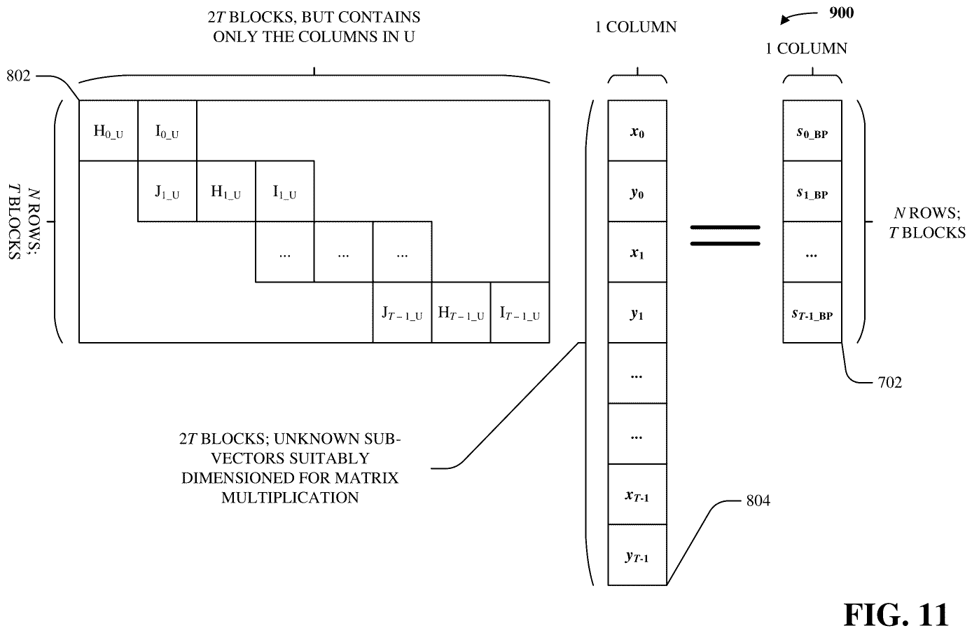

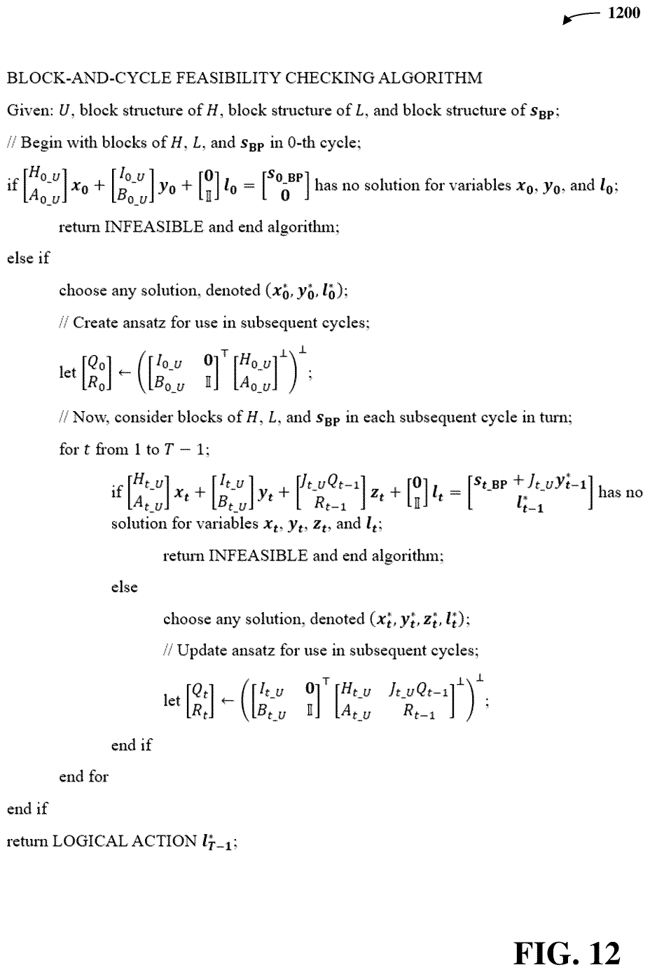

Now, consider FIGS. 11-12, which show various non-limiting aspects of the block-and-cycle feasibility checking algorithm 604.

First, consider FIG. 11, which illustrates how the block-and-cycle structure of the parity check matrix 114 can be considered as applying to the shrunken linear system 900.

As mentioned above, the subset of columns 802 (which can be denoted as U) can be considered as forming a new matrix (e.g., H_{U}). Such new matrix can have the same number of rows as the parity check matrix 114 (e.g., a total of N rows), and such new matrix can have however many columns are in the subset of columns 802. In various instances, that new matrix can be considered as an even more sparce version of the parity check matrix 114. Thus, that new matrix can be considered as having the same T-by-2T arrangement of H-blocks, I-blocks, and J-blocks as the parity check matrix 114, but such blocks can be partially or fully empty due to restriction to the subset of columns 802. As a non-limiting example, the cycle 0 block-row of that new matrix can contain an H-block denoted H_{0_U} and an I-block denoted I_{0_U}, where H_{0_U} can have the same intra-matrix location as H₀ but can contain only the numerical elements (if any) of H₀ that are present in the subset of columns 802, and where I_{0_U} can have the same intra-matrix location as I₀ but can contain only the numerical elements (if any) of I₀ that are present in the subset of columns 802. Accordingly, it is possible for H_{0_U} or I_{0_U} to be partially or fully empty and thus much easier to invert (as compared to inverting the parity check matrix 114 or the new matrix formed by the subset of columns 802). As another non-limiting example, the cycle 1 block-row of that new matrix can contain an H-block denoted H_{1_U}, an I-block denoted I_{1_U}, and a J-block denoted J_{1_U}, where H_{1_U} can have the same intra-matrix location as H₁ but can contain only the numerical elements (if any) of H₁ that are present in the subset of columns 802, where I_{1_U} can have the same intra-matrix location as I₁ but can contain only the numerical elements (if any) of I₁ that are present in the subset of columns 802, and where J_{1_U} can have the same intra-matrix location as J₁ but can contain only the numerical elements (if any) of J₁ that are present in the subset of columns 802. Accordingly, it is possible for H_{1_U}, I_{1_U}, or J_{1_U} to be partially or fully empty and thus very easy to invert. As yet another non-limiting example, the cycle T−1 block-row of that new matrix can contain an H-block denoted H_{T-1_U}, an I-block denoted I_{T-1_U}, and a J-block denoted J_{T-1_U}, where H_{T-1_U} can have the same intra-matrix location as H_{T-1} but can contain only the numerical elements (if any) of H_{T-1} that are present in the subset of columns 802, where I_{T-1_U} can have the same intra-matrix location as I_{T-1} but can contain only the numerical elements (if any) of I_{T-1} that are present in the subset of columns 802, and where J_{T-1_U} can have the same intra-matrix location as J_{T-1} but can contain only the numerical elements (if any) of J_{T-1} that are present in the subset of columns 802. Accordingly, it is possible for H_{T-1_U}, I_{T-1_U}, or J_{T-1_U} to be partially or fully empty and thus quite easy to invert.

As also mentioned above, the subset of rows 804 can be considered as forming a new variable vector (e.g., Δe). Such new variable vector can have the same number of columns as the variable vector 704 (e.g., a single column), and such new variable vector can have however many rows are in the subset of rows 804. In various aspects, that new variable vector can be broken up into 2T blocks, each of such blocks being an unknown sub-vector that is suitably or appropriately dimensioned so as to facilitate matrix multiplication with the new matrix formed by the subset of columns 802. In particular, each adjacent pair of blocks in that new variable vector can correspond to a respective syndrome measurement cycle, with one of such adjacent pair of blocks being suitably dimensioned for matrix multiplication with whatever restricted H-block of the new matrix corresponds to that respective syndrome measurement cycle, and with the other of such adjacent pair of blocks being suitably dimensioned for matrix multiplication with whatever restricted I-block of the new matrix corresponds to that respective syndrome measurement cycle. As a non-limiting example, the cycle 0 block pair of that new variable vector can include an unknown block x₀ that can be multiplied by H_{0_U}, and can include an unknown block y₀ that can be multiplied by I_{0_U}. As another non-limiting example, the cycle 1 block pair of that new variable vector can include an unknown block x₁ that can be multiplied by H_{1_U}, and can include an unknown block y₁ that can be multiplied by I_{1_U}. Note that matrix multiplication with respect to cycle 1 can cause the unknown block y₀ to be multiplied by J_{1_U}. As still another non-limiting example, the cycle T−1 block pair of that new variable vector can include an unknown block x_{T-1} that can be multiplied by H_{T-1_U}, and can include an unknown block y_{T-1} that can be multiplied by I_{T-1_U}. Note that matrix multiplication with respect to cycle T−1 can cause an unknown block y_{T-2} (not shown) to be multiplied by J_{T-1_U}.

In various aspects, the residual syndrome 702 can, as mentioned above, have a single column and N rows. In various instances, the residual syndrome 702 can be broken up into T blocks, each of such blocks being a known sub-vector of length n. In various cases, each block of the residual syndrome 702 can correspond to a respective syndrome measurement cycle. As a non-limiting example, a block s_{0_BP} can correspond to the cycle 0. By performing the depicted matrix multiplication, this can be interpreted to mean that H_{0_U}x₀+I_{0_U}y₀=s_{0_BP}. As another non-limiting example, a block s_{1_U} BP can correspond to the cycle 1. By performing the depicted matrix multiplication, this can be interpreted to mean that J_{1_U}y₀+H_{1_U}x₁+I_{1_U}y₁=s_{1_BP}. As yet another non-limiting example, a block s_{T-1_BP} can correspond to the cycle T−1. By performing the depicted matrix multiplication, this can be interpreted to mean that J_{T-1_U}y_{T-2}+H_{T-1_U}x_{T-1}+I_{T-1_U}y_{T-1}=s_{T-1_BP}.

Now, consider FIG. 12, which illustrates a non-limiting, example embodiment of the block-and-cycle feasibility checking algorithm 604. Before delving into the details of FIG. 12, consider the following observations that the present inventors made or recognized.

When given a vector w₀ that satisfies some linear system, for any vector z, there exists a matrix W₀ such that wₒ^{*}=w₀+W₀z also satisfies that linear system. This can be referred to as vector extension.

Consider a binary matrix D having r rows and d columns (e.g., D∈{0,1}^{r×c}). By applying Gaussian elimination to D, the following can be identified: p¹, p², . . . , p^{r-rank(D)} which can be any linearly independent vectors orthogonal modulo two to all columns of D. In various aspects, p¹, p², . . . , p^{r-rank(D)} can be considered as collectively forming a new matrix D^{⊥}. By definition, this means that D^{⊥} has r rows and at most c columns.

Consider a linear system Ea+Fb=d, where E and F are matrices of sizes r×c_{E} and r×c_{F} respectively, where a and b are vectors of length c_{E} and c_{F} respectively, and where d is a vector of length r. Suppose that this system is feasible or solvable (e.g., via Gaussian elimination), where (a*, b*) is a solution to such system. Then, there exists a matrix G with c_{F} rows and at most c_{F} columns such that the following is true: (a*, b**) is also a solution to the linear system, where b**=b*+Gz for some vector z, where G=(F^{T}E^{⊥})^{⊥}, and where F^{T} is the transpose of F.

With these observations in mind, consider FIG. 12, which depicts an example, non-limiting pseudocode for the block-and-cycle feasibility checking algorithm 604.

In various embodiments, the block-and-cycle feasibility checking algorithm 604 can be given access to the subset of columns 802 denoted U, to the block structure of the parity check matrix 114 denoted H, to the block structure of the logical action matrix 116 denoted L, and to the block structure of the residual syndrome 702 denoted s_{BP}.

In various aspects, the block-and-cycle feasibility checking algorithm 604 can consider each of the T syndrome measurement cycles in turn, starting or beginning with the cycle 0.

For the cycle 0, the block-and-cycle feasibility checking algorithm 604 can construct a linear system that is even smaller than the shrunken linear system 900. Such linear system can be:

$$[ \begin{matrix}{H}_{0 \_ U} \\ {A}_{0 \_ U}\end{matrix} ] {x}_{0} + [ \begin{matrix}{I}_{0 \_ U} \\ {B}_{0 \_ U}\end{matrix} ] {y}_{0} + [ \begin{matrix}0 \\ 𝕀\end{matrix} ] {l}_{0} = [ \begin{matrix}{s}_{0 \_ BP} \\ 0\end{matrix} ]$$

where x₀, y₀, s_{0_BP}, H_{0_U}, and I_{0_U} are defined with respect to FIG. 11; where A_{0_U} can have the same intra-matrix location as A₀ from the logical action matrix 116 but can contain only the numerical elements (if any) of A₀ whose column indices match those in the subset of columns 802; where B_{0_U} can have the same intra-matrix location as B₀ from the logical action matrix 116 but can contain only the numerical elements (if any) of B₀ whose column indices match those in the subset of columns 802; where 0 is a zero matrix; where II is an identity matrix; and where l₀ is an additional or auxiliary variable vector. Note how H_{0_U} and I_{0_U} are respectively stacked on or with A_{0_U} and B_{0_U}. Also note how the coefficients of l₀ are formed by stacking: a zero matrix that is in line with the column-restricted blocks of the parity check matrix 114; on or with an identity matrix that is in line with the column-restricted blocks of the logical action matrix 116. If such linear system has no solution for the variables x₀, y₀, and l₀ (e.g., this can be quickly determined via Gaussian elimination, given how dimensionally-small such linear system is), then the block-and-cycle feasibility checking algorithm 604 can return INFEASIBLE and can end. When implemented in the context of the computer-implemented method 1000, such ending can lead to act 1010 or act 1016. On the other hand, if such linear system has a solution, then

$${x}_{0}^{*} , {y}_{0}^{*} , and {l}_{0}^{*}$$

be any such solution (e.g., again, can be quickly determined via Gaussian elimination since the linear system is so small). In various instances, the block-and-cycle feasibility checking algorithm 604 can then create an ansatz

$$[ \begin{matrix}{Q}_{0} \\ {R}_{0}\end{matrix} ]$$

for use during subsequent cycles, with such ansatz being given by:

$$[ \begin{matrix}{Q}_{0} \\ {R}_{0}\end{matrix} ] ← {( {{[ \begin{matrix}{I}_{0 \_ U} & 0 \\ {B}_{0 \_ U} & 𝕀\end{matrix} ]}^{⊤} [ \begin{matrix}{H}_{0 \_ U} \\ {A}_{0 \_ U}\end{matrix} ]}^{⊥} )}^{⊥}$$

Next, for each cycle t for t from 1 to T−1, the block-and-cycle feasibility checking algorithm 604 can construct a respective linear system that is even smaller than the shrunken linear system 900. Such respective linear system can be:

$$[ \begin{matrix}{H}_{t\_U} \\ {A}_{t\_U}\end{matrix} ] {x}_{t} + [ \begin{matrix}{I}_{t\_U} \\ {B}_{t \_ U}\end{matrix} ] {y}_{t} + [ \begin{matrix}{J}_{t\_U} {Q}_{t - 1} \\ {R}_{t - 1}\end{matrix} ] {z}_{t} + [ \begin{matrix}0 \\ 𝕀\end{matrix} ] {l}_{t} = [ \begin{matrix}{s}_{t\_BP} + {J}_{t\_U} {y}_{t - 1}^{*} \\ {l}_{t - 1}^{*}\end{matrix} ]$$

where xₜ, yₜ, s_{t_BP}, H_{t_U}, I_{t_U}, and J_{t_U} are defined with respect to FIG. 11; where A_{t_U} can have the same intra-matrix location as Aₜ from the logical action matrix 116 but can contain only the numerical elements (if any) of Aₜ whose column indices match those in the subset of columns 802; where B_{t_U} can have the same intra-matrix location as Bₜ from the logical action matrix 116 but can contain only the numerical elements (if any) of Bₜ whose column indices match those in the subset of columns 802; and where zₜ and lₜ are additional or auxiliary variable vectors. Again, note how H_{t_U} and I_{t_U} are respectively stacked on or with A_{t_U} and B_{t_U}. Also again note how the coefficients of lₜ are formed by stacking: a zero matrix that is in line with the column-restricted blocks of the parity check matrix 114; on or with an identity matrix that is in line with the column-restricted blocks of the logical action matrix 116. Lastly, note how the coefficients of zₜ are formed from the ansatz of a previous cycle. If such linear system has no solution for the variables xₜ, yₜ, zₜ, and lₜ (e.g., quickly determined via Gaussian elimination given small dimensionality), then the block-and-cycle feasibility checking algorithm 604 can return INFEASIBLE and can end. As above, when implemented in the context of the computer-implemented method 1000, such ending can lead to act 1010 or act 1016. On the other hand, if such linear system has a solution, then let

$${x}_{t}^{*} , {y}_{t}^{*} , {z}_{t}^{*} ,$$

and

$${l}_{t}^{*}$$

be any such solution. In various instances, the block-and-cycle feasibility checking algorithm 604 can then create an ansatz

$$[ \begin{matrix}{Q}_{t} \\ {R}_{t}\end{matrix} ]$$

for use during subsequent cycles, with such ansatz being given by:

$${{{[ \begin{matrix}{Q}_{t} \\ {R}_{t}\end{matrix} ] ← ( [ \begin{matrix}{I}_{t\_U} & 0 \\ {B}_{t\_U} & 𝕀\end{matrix} ] ]}^{⊤} [ \begin{matrix}{H}_{t\_U} & {J}_{t\_U} {Q}_{t - 1} \\ {A}_{t\_U} & {R}_{t - 1}\end{matrix} ]}^{⊥} )}^{⊥}$$

In various aspects, once the block-and-cycle feasibility checking algorithm 604 solves whatever dimensionally-reduced linear system is created from the blocks of the cycle T−1, the block-and-cycle feasibility checking algorithm 604 can produce as output

$${l}_{T - 1}^{*} .$$

Note that, as utilized in the pseudocode 1200, the additional or auxiliary variable lₜ can be considered as a bitstring of length k that tracks, records, or accumulates whatever incremental logical action is imparted onto the set of logical qubits 106 by whatever faults are detected in respective syndrome measurement cycles. That is, the following is forced or necessarily implied by the pseudocode 1200:

$${l}_{t} = {\sum }_{i = 0}^{t} {A}_{i} {x}_{i} + {B}_{i} {y}_{i} .$$

Because the linear systems utilized in the block-and-cycle feasibility checking algorithm 604 are based on the residual syndrome 702, the value of

$${l}_{T - 1}^{*}$$

can be considered as being equal to the cumulative amount of logical action that is not accounted for or caused by the candidate error 402 but that was nevertheless imparted onto the set of logical qubits 106. Accordingly, in various instances, the logical action 602 (e.g., a net amount of logical action imparted onto the set of logical qubits 106 by the actual error e) can be computed by adding

$${l}_{T - 1}^{*}$$

to a product between: the logical action matrix 116; and the candidate error 402.

Although not explicitly shown in FIG. 12, the block-and-cycle feasibility checking algorithm 604 can include an additional action. Specifically, if R_{T-1} is a non-zero matrix, then the block-and-cycle feasibility checking algorithm 604 can indicate that the cumulative amount of logical action indicated by

$${l}_{T - 1}^{*}$$

is non-unique. This can serve as a warning that further analysis might be required.

In various embodiments, the correction component 128 can electronically correct or undo the logical action 602. As a non-limiting example, the correction component 128 can invert the logical action 602 (e.g., which can be considered as quick and easy since

$${l}_{T - 1}^{*} ∈ {\{ 0 , 1 \}}^{k}$$

is orders of magnitude smaller than H or L) and can execute the result of such inversion on the set of logical qubits 106. In this way, although the quantum states of the set of logical qubits 106 can have been afflicted with errors that occurred during the execution of the QEC circuit 110, such errors can be considered as being cancelled or erased via execution of the inverse of the logical action 602.

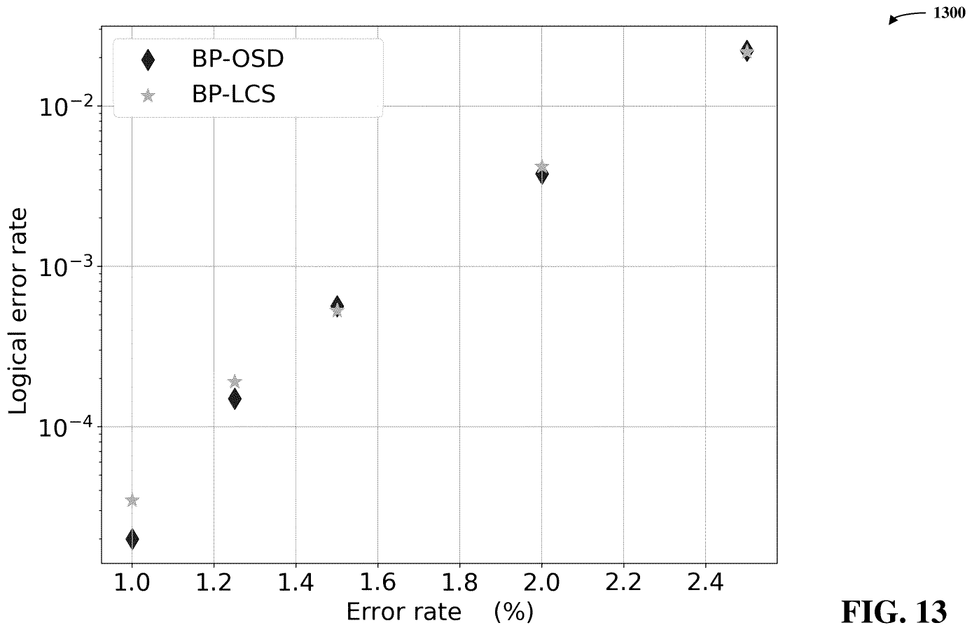

FIGS. 13-16 illustrate example, non-limiting experimental results in accordance with one or more embodiments described herein.

FIG. 13 depicts a graph 1300 of logical error rate (e.g., probability of an error occurring during QEC decoding) as a function of physical error rate (e.g., probability of an error occurring during the execution of quantum gates on physical qubits). The present inventors conducted various experiments in which logical error rate and physical error rate were recorded for quantum error correction performed in two different ways. One of those ways utilized belief propagation (BP) for pre-decoding and OSD for decoding (collectively denoted as BP-OSD). The other of those ways utilized belief propagation for pre-decoding and various embodiments described herein (which the present inventors sometimes refer to as “LCS” or “logical-class subset” decoding, since direct computation of the actual error e is eschewed for direct computation of logical action by various embodiments described herein). As shown, the herein described embodiments (denoted BP-LCS) were able to achieve comparable (indeed, nearly identical) logical error rates as OSD at all physical error rates. In other words, various embodiments described herein facilitated quantum error correction decoding with comparable accuracy as OSD.

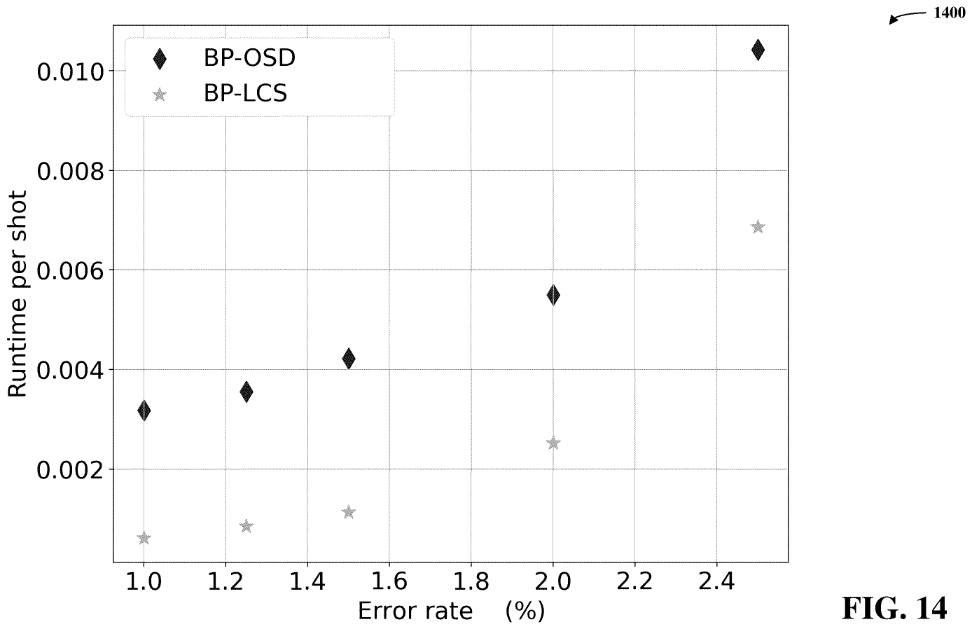

FIG. 14 depicts a graph 1400 of runtime per shot (e.g., measured in seconds) as a function of physical error rate. As shown, the herein described embodiments consumed significantly less runtime than OSD at all physical error rates. In other words, when FIGS. 13-14 are considered together, various embodiments described herein facilitated quantum error correction decoding much more quickly than, but nevertheless with comparable accuracy as, OSD.

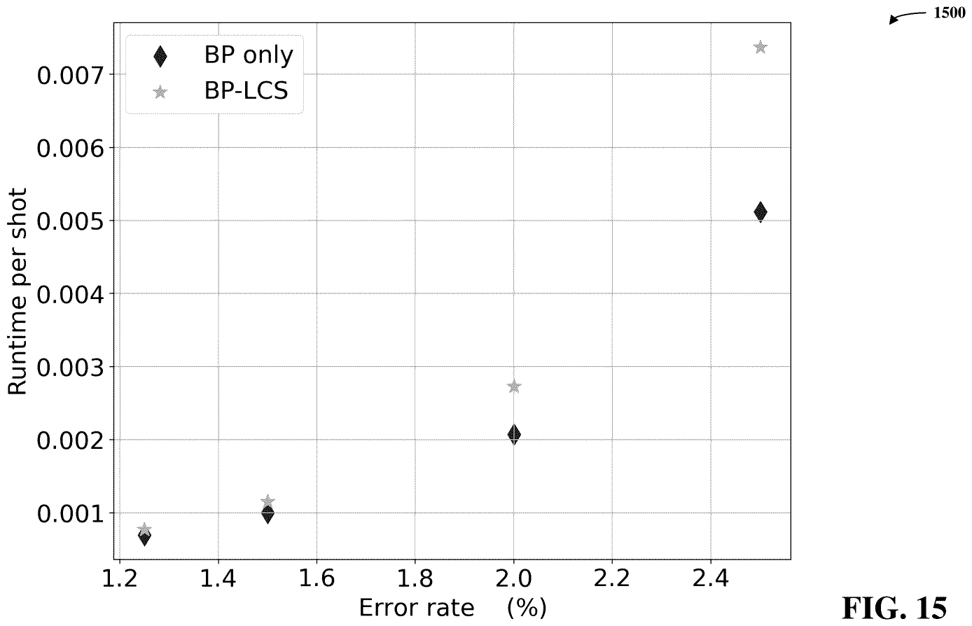

FIG. 15 depicts a graph 1500 of runtime per shot as a function of physical error rate. However, rather than comparing BP-OSD to BP-LCS, the graph 1500 instead compares belief propagation alone to BP-LCS. The graph 1500 can be considered as indicating that the majority all time consumed by BP-LCS is due to belief propagation and not to LCS. In other words, the herein described embodiments can be considered as adding extremely little overhead or computational cost to belief propagation.

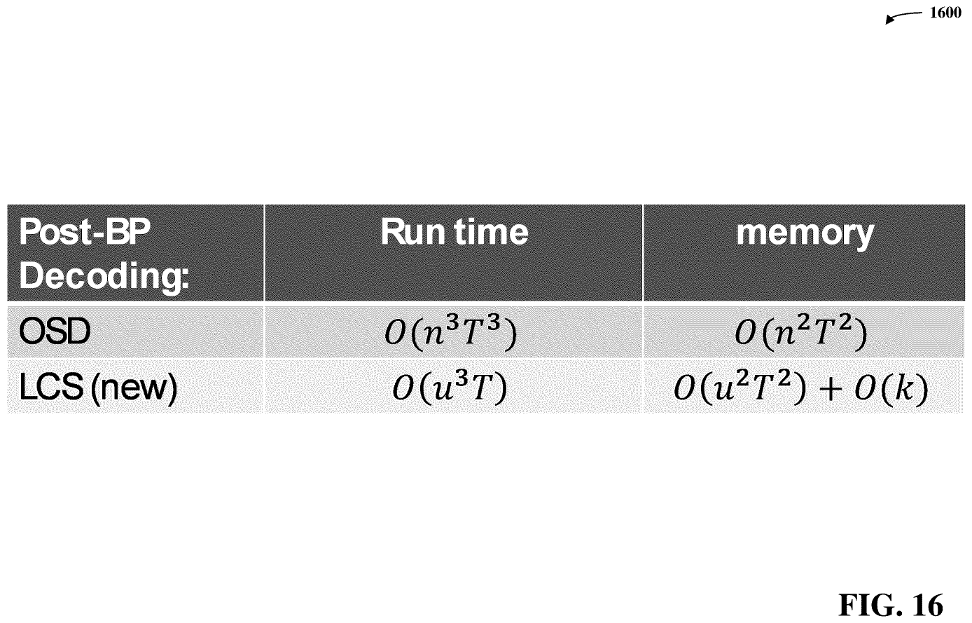

FIG. 16 depicts a table 1600 showing the growth rates of runtime and memory exhibited by OSD versus those exhibited by various embodiments described herein (denoted “LCS”). As shown, the runtime of OSD is proportional to the cube of n (e.g., cube of the total number of qubits involved in the QEC circuit 110) and to the cube of T (e.g., to the cube of the total number of syndrome measurement cycles). In stark contrast, the runtime of LCS is proportional to T and to the cube of u, where u represents the number of unreliable or low-reliability columns of the parity check matrix 114. It is clear that T grows much less quickly than T³. Additionally, because it is almost always the case that u<<n, it is also clear that u³ grows much less quickly than n³. Thus, the runtime of various embodiments described is much lower than the runtime of OSD. As also shown, the memory consumption of OSD is proportional to the square of n and to the square of T. In stark contrast, the memory consumption of LCS is proportional to T and to the square of u. Again, it is clear that T grows much less quickly than T². Moreover, because it is almost always the case that u<<n, it is also clear that u² grows much less quickly than n². So, the memory consumption of various embodiments described is much lower than the memory consumption of OSD.

The experimental results shown in FIGS. 13-16 help to demonstrate the real-world technical benefits achieved by block-and-cycle feasibility checking as described herein. Specifically, such real-world technical benefits include fast, quick, or otherwise non-time-consuming performance of QEC decoding without sacrificing accuracy. This can be considered as concretely advantageous in the real-world, since various embodiments described herein allow QEC decoding to be more easily performed in real-time as the quantum computer 104 is running or being controlled (e.g., while the quantum computer 104 is actively executing circuits). Even in situations where the quantum computer 104 is not running or being controlled in real-time (e.g., it can be possible for the syndrome measurement 112 to be computed from a classical simulation of the QEC circuit 110 rather than extracted from actual execution of the QEC circuit 110 on the quantum computer 104), faster and less memory-intensive performance of QEC decoding can nevertheless be considered as beneficial or desirable.

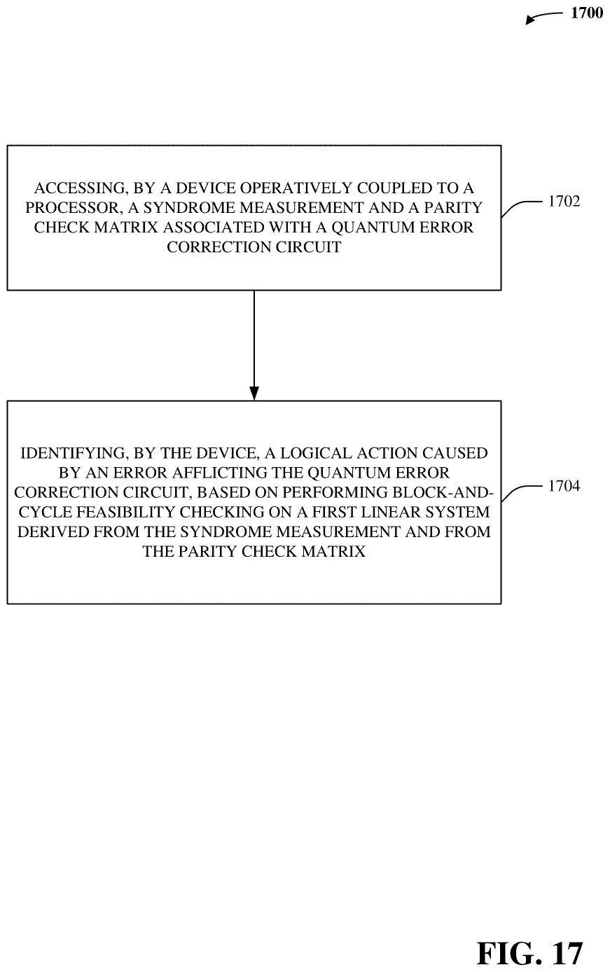

FIG. 17 illustrates a flow diagram of an example, non-limiting computer-implemented method 1700 that can facilitate quantum error correction decoding via block-and-cycle feasibility checking in accordance with one or more embodiments described herein. In various cases, the error correcting system 102 can facilitate the computer-implemented method 1700.

In various embodiments, act 1702 can include accessing, by a device (e.g., via 122) operatively coupled to a processor (e.g., 118), a syndrome measurement (e.g., 112) and a parity check matrix (e.g., 114) associated with a quantum error correction circuit (e.g., 110).

In various aspects, act 1704 can include identifying, by the device (e.g., via 126), a logical action (e.g., 602) caused by an error (e.g., e) afflicting the quantum error correction circuit, based on performing block-and-cycle feasibility checking (e.g., 604) on a first linear system (e.g., 900) derived from the syndrome measurement and from the parity check matrix.

Although not explicitly shown in FIG. 17, the computer-implemented method 1700 can include: correcting, by the device (e.g., via 128), the error based on applying an inverse of the logical action to the quantum error correction circuit.

Although not explicitly shown in FIG. 17, the computer-implemented method 1700 an include generating, by the device (e.g., via 124) and via application of a pre-decoding algorithm to the quantum error correction circuit and to the syndrome measurement, a candidate error (e.g., 402) and fault probabilities (e.g., 502) respectively corresponding to columns of the parity check matrix, wherein the device can convert the fault probabilities into column-wise reliabilities (e.g., 404). In various cases, the pre-decoding algorithm can be belief propagation.

Although not explicitly shown in FIG. 17, the first linear system can be a dimensionally-reduced version of a second linear system (e.g., 700), wherein the second linear system can equate: a first vector (e.g., 702) that is equal to a sum of: a product between the parity check matrix and the candidate error; and the syndrome measurement; to a product between the parity check matrix and a second vector (e.g., 704) to be identified. In various instances, the first linear system can equate: the first vector; to a product between a subset of columns (e.g., 802) of the parity check matrix and a respectively corresponding subset of elements (e.g., 804) from the second vector.

Although not explicitly shown in FIG. 17, the device can: initialize the subset of columns as a least reliable column of the parity check matrix; iteratively add new columns from the parity check matrix to the subset of columns in order of increasing reliability, in response to the block-and-cycle feasibility checking indicating that the first linear system is infeasible; or iteratively remove columns from the subset of columns in order of decreasing reliability, in response to the block-and-cycle feasibility checking indicating that the first linear system is feasible (e.g., as shown in FIG. 10).

Although not explicitly shown in FIG. 17, a logical action matrix (e.g., 116) can be associated with the quantum error correction circuit, and, for a current cycle (e.g., t), the block-and-cycle feasibility checking can include: applying, by the device (e.g., via 126), Gaussian elimination to a third linear system (e.g., shown in FIG. 12): whose coefficients are formed by stacking: first blocks of the parity check matrix (e.g., H_{t_U}, I_{t_U}) corresponding to the current cycle and restricted to the subset of columns; with second blocks of the logical action matrix (e.g., A_{t_U}, B_{t_U}) corresponding to the current cycle and restricted to the subset of columns; and whose variables include a logical-action-tracking variable (e.g., lₜ).

Although various embodiments are described herein in which the access component 122 receives, retrieves, imports, or otherwise accesses the syndrome measurement 112 from any suitable database or computing device after the syndrome measurement 112 has already been extracted from, during, or after execution of the QEC circuit 110, these are mere non-limiting examples for ease of explanation and illustration. Indeed, in some embodiments, the QEC circuit 110 can have not yet been executed on the quantum computer 104, which means that the syndrome measurement 112 cannot yet exist. In such situations, the access component 122 can: electronically cause the QEC circuit 110 to be executed on the quantum computer 104 (e.g., using any suitable quantum state initializations of the set of logical qubits 106 and of the set of ancillary qubits 108); and electronically cause the syndrome measurement 112 to be measured, read, or otherwise extracted during or after such execution by activating, invoking, or otherwise controlling any suitable quantum measurement or readout hardware of the quantum computer 104.

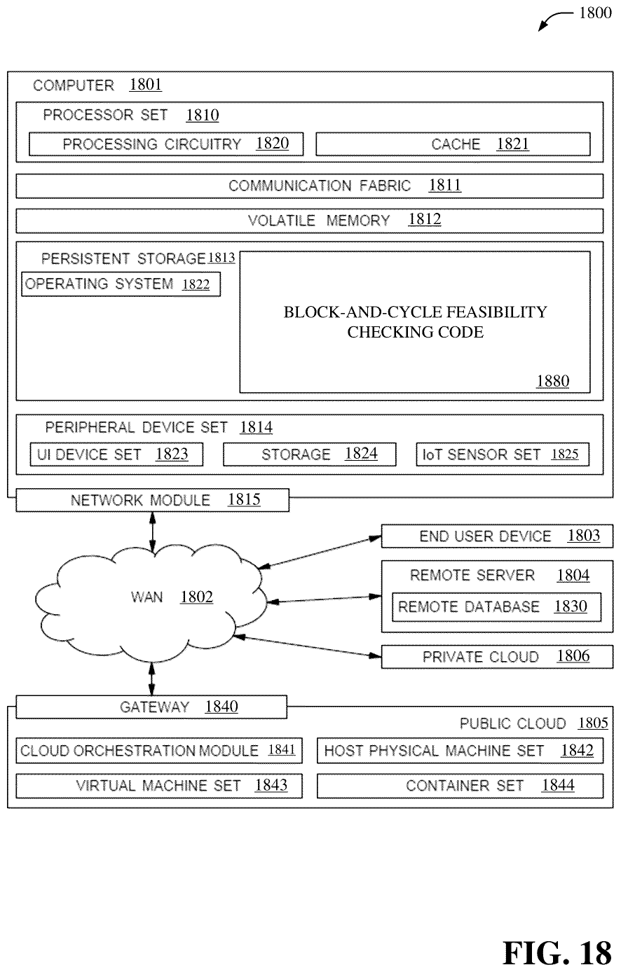

FIG. 18 and the following discussion are intended to provide a brief, general description of a suitable computing environment 1800 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1800 contains an example of an environment for the execution of at least some of the computer code involved in performing the inventive methods, such as block-and-cycle feasibility checking code 1880. In addition to block 1880, computing environment 1800 includes, for example, computer 1801, wide area network (WAN) 1802, end user device (EUD) 1803, remote server 1804, public cloud 1805, and private cloud 1806. In this embodiment, computer 1801 includes processor set 1810 (including processing circuitry 1820 and cache 1821), communication fabric 1811, volatile memory 1812, persistent storage 1813 (including operating system 1822 and block 1880, as identified above), peripheral device set 1814 (including user interface (UI), device set 1823, storage 1824, and Internet of Things (IoT) sensor set 1825), and network module 1815. Remote server 1804 includes remote database 1830. Public cloud 1805 includes gateway 1840, cloud orchestration module 1841, host physical machine set 1842, virtual machine set 1843, and container set 1844.

COMPUTER 1801 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1830. As is well understood in the art of computer technology, and depending upon the technology, performance of a computer-implemented method can be distributed among multiple computers or between multiple locations. On the other hand, in this presentation of computing environment 1800, detailed discussion is focused on a single computer, specifically computer 1801, to keep the presentation as simple as possible. Computer 1801 can be located in a cloud, even though it is not shown in a cloud in FIG. 18. On the other hand, computer 1801 is not required to be in a cloud except to any extent as can be affirmatively indicated.

PROCESSOR SET 1810 includes one, or more, computer processors of any type now known or to be developed in the future. Processing circuitry 1820 can be distributed over multiple packages, for example, multiple, coordinated integrated circuit chips. Processing circuitry 1820 can implement multiple processor threads or multiple processor cores. Cache 1821 is memory that is located in the processor chip package(s) and is typically used for data or code that should be available for rapid access by the threads or cores running on processor set 1810. Cache memories are typically organized into multiple levels depending upon relative proximity to the processing circuitry. Alternatively, some, or all, of the cache for the processor set can be located “off chip.” In some computing environments, processor set 1810 can be designed for working with qubits and performing quantum computing.

Computer readable program instructions are typically loaded onto computer 1801 to cause a series of operational steps to be performed by processor set 1810 of computer 1801 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1821 and the other storage media discussed below. The program instructions, and associated data, are accessed by processor set 1810 to control and direct performance of the inventive methods. In computing environment 1800, at least some of the instructions for performing the inventive methods can be stored in block 1880 in persistent storage 1813.

COMMUNICATION FABRIC 1811 is the signal conduction path that allows the various components of computer 1801 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1812 is any type of volatile memory now known or to be developed in the future. Examples include dynamic type random access memory (RAM) or static type RAM. Typically, the volatile memory is characterized by random access, but this is not required unless affirmatively indicated. In computer 1801, the volatile memory 1812 is located in a single package and is internal to computer 1801, but, alternatively or additionally, the volatile memory can be distributed over multiple packages or located externally with respect to computer 1801.

PERSISTENT STORAGE 1813 is any form of non-volatile storage for computers that is now known or to be developed in the future. The non-volatility of this storage means that the stored data is maintained regardless of whether power is being supplied to computer 1801 or directly to persistent storage 1813. Persistent storage 1813 can be a read only memory (ROM), but typically at least a portion of the persistent storage allows writing of data, deletion of data and re-writing of data. Some familiar forms of persistent storage include magnetic disks and solid-state storage devices. Operating system 1822 can take several forms, such as various known proprietary operating systems or open-source Portable Operating System Interface type operating systems that employ a kernel. The code included in block 1880 typically includes at least some of the computer code involved in performing the inventive methods.

PERIPHERAL DEVICE SET 1814 includes the set of peripheral devices of computer 1801. Data communication connections between the peripheral devices and the other components of computer 1801 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1823 can include components such as a display screen, speaker, microphone, wearable devices (such as goggles and smart watches), keyboard, mouse, printer, touchpad, game controllers, and haptic devices. Storage 1824 is external storage, such as an external hard drive, or insertable storage, such as an SD card. Storage 1824 can be persistent or volatile. In some embodiments, storage 1824 can take the form of a quantum computing storage device for storing data in the form of qubits. In embodiments where computer 1801 is required to have a large amount of storage (for example, where computer 1801 locally stores and manages a large database) then this storage can be provided by peripheral storage devices designed for storing large amounts of data, such as a storage area network (SAN) that is shared by multiple, geographically distributed computers. IoT sensor set 1825 is made up of sensors that can be used in Internet of Things applications. For example, one sensor can be a thermometer and another sensor can be a motion detector.

NETWORK MODULE 1815 is the collection of computer software, hardware, and firmware that allows computer 1801 to communicate with other computers through WAN 1802. Network module 1815 can include hardware, such as modems or Wi-Fi signal transceivers, software for packetizing or de-packetizing data for communication network transmission, or web browser software for communicating data over the internet. In some embodiments, network control functions and network forwarding functions of network module 1815 are performed on the same physical hardware device. In other embodiments (for example, embodiments that utilize software-defined networking (SDN)), the control functions and the forwarding functions of network module 1815 are performed on physically separate devices, such that the control functions manage several different network hardware devices. Computer readable program instructions for performing the inventive methods can typically be downloaded to computer 1801 from an external computer or external storage device through a network adapter card or network interface included in network module 1815.

WAN 1802 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1803 is any computer system that is used and controlled by an end user (for example, a customer of an enterprise that operates computer 1801) and can take any of the forms discussed above in connection with computer 1801. EUD 1803 typically receives helpful and useful data from the operations of computer 1801. For example, in a hypothetical case where computer 1801 is designed to provide a recommendation to an end user, this recommendation would typically be communicated from network module 1815 of computer 1801 through WAN 1802 to EUD 1803. In this way, EUD 1803 can display, or otherwise present, the recommendation to an end user. In some embodiments, EUD 1803 can be a client device, such as thin client, heavy client, mainframe computer or desktop computer.

REMOTE SERVER 1804 is any computer system that serves at least some data or functionality to computer 1801. Remote server 1804 can be controlled and used by the same entity that operates computer 1801. Remote server 1804 represents the machine(s) that collect and store helpful and useful data for use by other computers, such as computer 1801. For example, in a hypothetical case where computer 1801 is designed and programmed to provide a recommendation based on historical data, then this historical data can be provided to computer 1801 from remote database 1830 of remote server 1804.

PUBLIC CLOUD 1805 is any computer system available for use by multiple entities that provides on-demand availability of computer system resources or other computer capabilities, especially data storage (cloud storage) and computing power, without direct active management by the scale. The direct and active management of the computing resources of public cloud 1805 is performed by the computer hardware or software of cloud orchestration module 1841. The computing resources provided by public cloud 1805 are typically implemented by virtual computing environments that run on various computers making up the computers of host physical machine set 1842, which is the universe of physical computers in or available to public cloud 1805. The virtual computing environments (VCEs) typically take the form of virtual machines from virtual machine set 1843 or containers from container set 1844. It is understood that these VCEs can be stored as images and can be transferred among and between the various physical machine hosts, either as images or after instantiation of the VCE. Cloud orchestration module 1841 manages the transfer and storage of images, deploys new instantiations of VCEs and manages active instantiations of VCE deployments. Gateway 1840 is the collection of computer software, hardware and firmware allowing public cloud 1805 to communicate through WAN 1802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1806 is similar to public cloud 1805, except that the computing resources are only available for use by a single enterprise. While private cloud 1806 is depicted as being in communication with WAN 1802, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1805 and private cloud 1806 are both part of a larger hybrid cloud.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on a computer, partly on a computer, as a stand-alone software package, partly on a computer or partly on a remote computer or entirely on the remote computer or server. In the latter scenario, the remote computer can be connected to a computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

While the subject matter has been described above in the general context of computer-executable instructions of a computer program product that runs on a computer or computers, those skilled in the art will recognize that the one or more embodiments herein also can be implemented at least partially in parallel with one or more other program modules. Generally, program modules include routines, programs, components or data structures that perform particular tasks or implement particular abstract data types. Moreover, the aforedescribed computer-implemented methods can be practiced with other computer system configurations, including single-processor or multiprocessor computer systems, mini-computing devices, mainframe computers, as well as computers, hand-held computing devices (e.g., PDA, phone), or microprocessor-based or programmable consumer or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples of various embodiments. For ease of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches or gates, in order to optimize space usage or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Also, the described memory components of systems or computer-implemented methods herein are intended to include, without being limited to including, these or any other suitable types of memory.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a processor that executes computer-executable components stored in a non-transitory computer-readable memory, wherein the computer-executable components comprise:
an access component that measures a syndrome measurement associated with a quantum error correction circuit and a parity check matrix; and
a decoder component that identifies a logical action caused by an error afflicting the quantum error correction circuit, based on performing block-and-cycle feasibility checking on a first linear system derived from the syndrome measurement and from the parity check matrix.

2. The system of claim 1, wherein the computer-executable components further comprise:
a correction component that corrects the error, based on applying an inverse of the logical action to the quantum error correction circuit.

3. The system of claim 1, wherein the computer-executable components further comprise:
a pre-decoder component that generates, via application of a pre-decoding algorithm to the quantum error correction circuit and to the syndrome measurement, a candidate error and fault probabilities respectively corresponding to columns of the parity check matrix, wherein the decoder component converts the fault probabilities into column-wise reliabilities.

4. The system of claim 3, wherein the pre-decoding algorithm is belief propagation.

5. The system of claim 3, wherein the first linear system is a dimensionally-reduced version of a second linear system, wherein the second linear system equates:
a first vector that is equal to a sum of:
a product between the parity check matrix and the candidate error; and
the syndrome measurement; to a product between the parity check matrix and a second vector to be identified.

6. The system of claim 5, wherein the first linear system equates:
the first vector; to
a product between a subset of columns of the parity check matrix and a respectively corresponding subset of elements from the second vector.

7. The system of claim 6, wherein the decoder component:
initializes the subset of columns as a least reliable column of the parity check matrix;
iteratively adds new columns from the parity check matrix to the subset of columns in order of increasing reliability, in response to the block-and-cycle feasibility checking indicating that the first linear system is infeasible; and
iteratively removes columns from the subset of columns in order of decreasing reliability, in response to the block-and-cycle feasibility checking indicating that the first linear system is feasible.

8. The system of claim 7, wherein the decoder component iteratively adds or removes columns to or from the subset of columns in a binary search fashion.

9. The system of claim 6, wherein a logical action matrix is associated with the quantum error correction circuit, and wherein, for a current cycle, the block-and-cycle feasibility checking comprises:
applying Gaussian elimination to a third linear system:
whose coefficients are formed by stacking:
first blocks of the parity check matrix corresponding to the current cycle and restricted to the subset of columns; with
second blocks of the logical action matrix corresponding to the current cycle and restricted to the subset of columns; and
whose variables include a logical-action-tracking variable.

10. A computer-implemented method, comprising:
measuring, by a device operatively coupled to a processor, a syndrome measurement associated with a quantum error correction circuit and a parity check matrix; and
identifying, by the device, a logical action caused by an error afflicting the quantum error correction circuit, based on performing block-and-cycle feasibility checking on a first linear system derived from the syndrome measurement and from the parity check matrix.

11. The computer-implemented method of claim 10, further comprising:
correcting, by the device, the error based on applying an inverse of the logical action to the quantum error correction circuit.

12. The computer-implemented method of claim 10, further comprising:
generating, by the device and via application of a pre-decoding algorithm to the quantum error correction circuit and to the syndrome measurement, a candidate error and fault probabilities respectively corresponding to columns of the parity check matrix, wherein the device converts the fault probabilities into column-wise reliabilities.

13. The computer-implemented method of claim 12, wherein the pre-decoding algorithm is belief propagation.

14. The computer-implemented method of claim 12, wherein the first linear system is a dimensionally-reduced version of a second linear system, wherein the second linear system equates:
a first vector that is equal to a sum of:
a product between the parity check matrix and the candidate error; and
the syndrome measurement; to a product between the parity check matrix and a second vector to be identified.

15. The computer-implemented method of claim 14, wherein the first linear system equates:
the first vector; to a product between a subset of columns of the parity check matrix and a respectively corresponding subset of elements from the second vector.

16. The computer-implemented method of claim 15, wherein the device:
initializes the subset of columns as a least reliable column of the parity check matrix;
iteratively adds new columns from the parity check matrix to the subset of columns in order of increasing reliability, in response to the block-and-cycle feasibility checking indicating that the first linear system is infeasible; and
iteratively removes columns from the subset of columns in order of decreasing reliability, in response to the block-and-cycle feasibility checking indicating that the first linear system is feasible.

17. The computer-implemented method of claim 16, wherein the device iteratively adds or removes columns to or from the subset of columns in a binary search fashion.

18. The computer-implemented method of claim 15, wherein a logical action matrix is associated with the quantum error correction circuit, and wherein, for a current cycle, the block-and-cycle feasibility checking comprises:
applying, by the device, Gaussian elimination to a third linear system:
whose coefficients are formed by stacking:
first blocks of the parity check matrix corresponding to the current cycle and restricted to the subset of columns; with
second blocks of the logical action matrix corresponding to the current cycle and restricted to the subset of columns; and
whose variables include a logical-action-tracking variable.

19. A computer program product for facilitating quantum error correction decoding via block-and-cycle feasibility checking, the computer program product comprising a non-transitory computer-readable memory having program instructions embodied therewith, the program instructions executable by a processor to cause the processor to:
measure a syndrome measurement associated with a quantum error correction circuit and a parity check matrix; and
identify a logical action caused by an error afflicting the quantum error correction circuit, based on performing block-and-cycle feasibility checking on a first linear system derived from the syndrome measurement and from the parity check matrix.

20. The computer program product of claim 19, wherein the program instructions are executable to cause the processor to:
correct the error based on applying an inverse of the logical action to the quantum error correction circuit.
